(19) United States
(12) Patent Application Publication
(10) Pub. No.: US 2004/0157560 A1
(43) Pub. Date: Aug. 12, 2004

(54) Data transmission apparatus

(75) Inventor: Shoichiro Yamasaki, Tokyo (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/771,189

(22) Filed: Feb. 4, 2004

(30) Foreign Application Priority Data
Feb. 5, 2003 (JP) 2003-028267

(51) Int. Cl. H04B 1/10; H04B 15/00; H04B 17/00

(52) U.S. Cl. 455/63.1; 455/67.11

(57) ABSTRACT

In a transmission-side data transmission apparatus, a first information component of information data, necessary for real-time reproduction, is transmitted at a first transmission rate that is always secured on a communication channel. The other second information component of the information data, which is necessary for lossless reproduction but not for real-time reproduction, is intermittently transmitted at a second transmission rate that is irregularly secured on the communication channel. On the other hand, in a receiving-side data transmission apparatus, first encoded data that has been transmitted at the first transmission rate is decoded and reproduced in real time. Second encoded data that has been intermittently transmitted at the second transmission rate is decoded and synthesized with the real-time information component, whereby reception information data corresponding to the transmission information data is losslessly reproduced.

### CROSS-REFERENCE TO RELATED APPLICATIONS

This application is based upon and claims the benefit of priority from prior Japanese Patent Application No. 2003-028267, filed Feb. 5, 2003, the entire contents of which are incorporated herein by reference.

### BACKGROUND OF THE INVENTION

1. Field of the Invention

The present invention relates to a data transmission apparatus used in a system wherein information data is transmitted using a communication channel with a transmission quality varying with time, such as a wireless communication channel.

2. Description of the Related Art

In a wireless communication channel, the transmission quality tends to vary with the passing of time due to an effect of phasing, etc. For example, in an environment wherein there is much noise or there are many interference waves, the transmission quality tends to deteriorate. On the other hand, in an environment wherein there is less noise or there are few interference waves, the transmission quality tends to be enhanced. In the prior art, in order to deal with the time-dependent variation in the transmission quality of the communication channel, adaptive modulation or adaptive encoding has been proposed.

A general wireless data transmission system using the adaptive modulation or adaptive encoding is configured, for example, as follows. A transmission device includes an information source encoding unit, an adaptive transmission unit, and a radio unit. In the information source encoding unit, input transmission information is orthogonal-transformed by an orthogonal transformer, and then quantized by a quantizer. The quantized information is entropy-encoded by an entropy encoder, and thus the amount of information is compressed. In the adaptive transmission unit, the encoded data output from the information source encoding unit is first input to a variable encoder. The variable encoder comprises an error correction encoder with a variable encoding ratio. The variable encoder subjects the input encoded data to an error correction encoding process. The error-correction-encoded data is then input to a variable modulator. The variable modulator comprises a modulator capable of adaptively variable-setting a modulation scheme. The variable modulator converts the input encoded data to a modulated signal according to the variable-set modulation scheme. The radio unit frequency-converts the modulated signal to a corresponding radio signal, and amplifies the radio signal up to a predetermined transmission power level. The radio unit sends the radio signal from an antenna to a wireless communication channel.

The encoding ratio of the variable encoder and the modulation scheme of the variable modulator are controlled by a communication channel condition detector. For example, when the transmission quality is good, the communication channel condition detector selects 64QAM (Quadrature Amplitude Modulation) as a modulation scheme in order to give priority to transmission efficiency, and sets it in the variable modulator. In addition, the communication channel condition detector selects an error correction encoding scheme with an encoding ratio of R=2/3 as an encoding scheme, and sets it in the variable encoder. As a result, it becomes possible to transmit a large quantity of information source encoded data in a short time period.

On the other hand, when the transmission quality is poor, the communication channel condition detector selects 4PSK (Phase Shift Keying) as a modulation scheme in order to give priority to a transmission error resistance, and sets it in the variable modulator. In addition, the communication channel condition detector selects an error correction encoding scheme with an encoding ratio of R=1/3 as an encoding scheme, and sets it in the variable encoder. As a result, it becomes possible to transmit data with fewer errors, despite the condition in which the transmission quality deteriorates.

On the other hand, a receiving device includes a radio unit, an adaptive reception unit and an information source decoding unit. The radio unit low-noise-amplifies a radio signal received by an antenna, and frequency-converts the amplified signal to a reception signal with an intermediate frequency or a base-band frequency. In the adaptive reception unit, the reception signal output from the radio unit is successively input to a variable demodulator and a variable decoder. The variable demodulator demodulates the reception signal according to a demodulation scheme, of which the transmission device informs the receiving device. The variable decoder performs error-correction decoding of the information source decoded data output from the variable demodulator. In the information source decoding unit, the information source data decoded by the adaptive reception unit is first entropy-decoded by an entropy decoder and then inverse-quantized by an inverse quantizer. The resultant data is subjected to inverse orthogonal transformation by an inverse orthogonal transformer. Further, the resultant data is reproduced and output as still image information data.

The above-described system configuration is shown in detail in FIG. 1 of Jpn. Pat. Appln. KOKAI Publication No. 9-135275. The structures of the encoder and decoder are described in Sadayasu ONO, “Easy-to-Understand Method of Realizing JPEG/MPEG2”, Ohmsha, Jul. 15, 1995, p. 47, “FIG. 4.1 Structure of DCT-based JPEG Encoder/Decoder”. Other related documents are Jpn. Pat. Appln. KOKAI Publication No. 2000-261398, and A. Skodras, C. Christopoulos and T. Ebrahimi, “The JPEG2000 Still Image Compression Standard”, IEEE Signal Processing Magazine, pp. 36-58, Sep. 2001.

In this type of system, a great amount of data is transmitted at a high transmission rate when the transmission quality is good, and a small amount of data is transmitted at a low transmission rate when the transmission quality is poor. Thus, although high-efficiency data transmission can be realized, a delay inevitably occurs at the time of reproducing information data because of a variation with time in transmission quality, that is, a time-dependent variation in transmission rate. This system, therefore, is very effective when information data such as still image data, which does not require real-time performance (i.e. real-time reproduction), is transmitted.

However, it is not possible to transmit, in real time or at a fixed delay time, motion picture data or audio data whose generated information amount varies with time, as in the case of TV telephone communication. The reason is that in this case there is no correlation between the time-dependent variation in generated information amount and the time-dependent variation in transmission quality. In order to ensure real-time reproduction, there is an idea that only basic components of motion picture data or audio data, which is the object of transmission, are transmitted. However, when the transmitted motion picture data or audio data needs to be edited after decoding, it is not possible to completely reproduce the original information data on the basis of the basic components alone. In short, reversible (lossless) reproduction cannot be performed.

Furthermore, Jpn. Pat. Appln. KOKAI Publication No. 2000-261398 describes a transmission system that changes a multiplexing ratio between real-time information and non-real-time information and a modulation system in accordance with a good or bad transmission environment. However, this transmission system uses adaptive modulation. Thus, since the transmission environment must be observed to select a modulation system, accuracy of the observation is required. Additionally, in the 16QAM or the 64QAM, there are bits in which bit errors easily occur and bits in which bit errors do not easily occur. However, no consideration is given in this regard.

### BRIEF SUMMARY OF THE INVENTION

The object of the present invention is to provide a data transmission apparatus which can transmit information data using a communication channel whose transmission quality varies with time, in the state in which both real-time reproduction and lossless reproduction are ensured.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a main structure of a transmission device of a data transmission system according to a first embodiment of the present invention;

FIG. 2 is a block diagram showing a main structure of a receiving device of the data transmission system according to the first embodiment of the invention;

FIG. 3 shows an example of a variation in transmission rate with the passing of time;

FIG. 4 is a block diagram showing a main structure of a transmission device of a data transmission system according to a second embodiment of the present invention;

FIG. 5 is a block diagram showing a main structure of a receiving device of the data transmission system according to the second embodiment of the invention;

FIG. 6 is a block diagram showing the structure of an adaptive transmission unit of a transmission device according to a third embodiment of the invention;

FIG. 7 is a block diagram showing a structure of an adaptive transmission unit of a transmission device according to a fourth embodiment of the present invention;

FIG. 8 is a block diagram showing a main structure of a transmission device of a data transmission system according to a fifth embodiment of the present invention;

FIG. 9 is a block diagram showing a main structure of a receiving device of the data transmission system according to the fifth embodiment of the invention;

FIG. 10 is a block diagram showing a main structure of a transmission device of a data transmission system according to a sixth embodiment of the present invention;

FIG. 11 is a block diagram showing a main structure of a receiving device of the data transmission system according to the sixth embodiment of the invention;

FIG. 12 is a block diagram showing a main structure of a transmission device to realize a first example of a ninth embodiment of the present invention;

FIG. 13 is a block diagram showing the main structure of the transmission device to realize second and third examples of the ninth embodiment of the invention; and

FIG. 14 is a block diagram showing the main structure of the transmission device to realize a fourth example of the ninth embodiment of the invention.

### DETAILED DESCRIPTION OF THE INVENTION

To begin with, the outline of an embodiment of a data transmission apparatus according to the present invention is described.

In an embodiment of the present invention, in a transmission-side data transmission device, a first information component of information data, which is necessary for real-time reproduction, is transmitted at a first transmission rate which can always be secured on a communication channel. On the other hand, the other second information component, which is necessary for lossless reproduction but not necessary for real-time reproduction, is intermittently transmitted at a second transmission rate which is irregularly secured on the communication channel. In a reception-side device, first encoded data transmitted at the first transmission rate is decoded and reproduced in real time. Second encoded data intermittently transmitted at the second transmission rate is decoded and combined with the aforementioned real-time information component, and reception information data corresponding to the transmission information data is losslessly reproduced.

Thus, the first information component necessary for real-time reproduction is transmitted in real time, while the second information component necessary for lossless reproduction can be transmitted and reproduced using a time period in which the transmission quality is good. In other words, information data, such as motion picture data and audio data, whose generated information amount varies with time, can be transmitted using a wireless communication channel whose transmission quality varies with time in the state in which both real-time reproduction and lossless reproduction are maintained.

The following process may be performed when the first transmission information data, which requires real-time reproduction, and the second transmission information data, which requires lossless reproduction, are transmitted using a communication channel whose transmission quality varies with the passing of time.

Specifically, in the transmission-side data transmission device, the first transmission information data is encoded by a first encoding scheme corresponding to the first transmission rate that can always be secured on the communication channel. The second transmission information data is once stored and then encoded by a second encoding scheme corresponding to the second transmission rate that is irregularly secured on the communication channel. The produced first and second encoded information data is converted to a modulated signal by a modulator, and the converted modulated signal is wirelessly transmitted to the communication channel.

In the reception-side data transmission device, the received modulated signal is demodulated and output as first demodulated data corresponding to the first encoded information data and as second demodulated data corresponding to the second encoded information data. The first demodulated data is decoded by a first decoding scheme corresponding to the first encoding scheme, and thus the first decoded data corresponding to the first transmission information data is output in real time. On the other hand, the second demodulated data is decoded by a second decoding scheme corresponding to the second encoding scheme, and then the decoded data is stored. Thereby, the lossless second decoded data corresponding to the second transmission information data is produced and output.

Accordingly, the first information data, which requires real-time reproduction, and the second information data, which requires lossless reproduction, unlike the first information data, can be transmitted in parallel over the same communication channel by using the first transmission rate that is always secured on the communication channel and the second transmission rate that is intermittently secured on the communication channel in accordance with the transmission quality. For example, while motion picture data or audio data is being transmitted in real-time, computer data such as explanations of the motion picture data and audio data can be transmitted in parallel in a lossless mode.

The separation between the first and second information components is realized as follows. The first information component is extracted by quantizing the transmission information data, and an information component that has been lost due to the quantization is extracted as the second information component. According to this process, the first and second information components can be separated relatively easily by using only a quantizer for extracting the first information component and a differential unit for extracting the second information component.

In the transmission-side data transmission device, the first information component and second information component are transmitted, with timestamps indicative of the temporal correspondence relationship therebetween being added to both the information components. On the other hand, in the reception-side data transmission device, the stored first decoded data and the second decoded data output from the second decoding means are synthesized in the state in which the temporal correspondency therebetween is established based on the timestamps added to these decoded data components. Thereby, the first decoded data and second decoded data can be synthesized, with the temporal correspondence therebetween being exactly established. Therefore, the transmission information data can be losslessly reproduced with high precision.

Moreover, the transmission-side data transmission device is equipped with an adaptive control circuit which determines the transmission quality of the communication channel. Based on the result of determination, at least one of two processes is performed: one process for adaptively variable-setting the second encoding scheme used by the second encoder, and the other process for adaptively variable-setting the modulation scheme used by the modulator.

On the other hand, in the reception-side data transmission device, the demodulator is provided with a modulation scheme determination circuit for determining the modulation scheme used by the transmission-side data transmission device. The demodulation scheme corresponding to the modulation scheme determined by the modulation scheme determination circuit is selectively used, thereby demodulating the received modulated signal. Further, the second decoder is provided with an encoding scheme determination circuit for determining the second encoding scheme used by the transmission-side data transmission device. The second decoding scheme corresponding to the second encoding scheme determined by the encoding scheme determination circuit is selectively used, thereby decoding the second demodulated data that is the object of decoding.

According to this structure, the second information component or the second information data, which is separated from the transmission information data, is encoded by an optimal encoding scheme corresponding to the transmission quality at each point in time, or modulated by an optimal modulation scheme, and the encoded/modulated information data is transmitted. Therefore, the second information component or second information data can be transmitted with a maximum transmission efficiency corresponding to the transmission quality at each point in time.

### FIRST EMBODIMENT

In a first embodiment of the present invention, in a transmission device, information source data, which is an object of transmission, is separated into first information data necessary for real-time reproduction and the other second information data necessary for lossless reproduction. The first information data and second information data are wirelessly transmitted using, respectively, a first transmission rate that can always be secured on the wireless communication channel and a second transmission rate that is irregularly secured on the channel when the transmission quality is good. In the receiving device, decoded data corresponding to the first information data is reproduced in real time and stored. Temporal correspondence is established between the stored first information data and decoded data corresponding to the second information data, and then these data components are synthesized. Thereby, the information source data, which is the object of transmission, is losslessly reproduced.

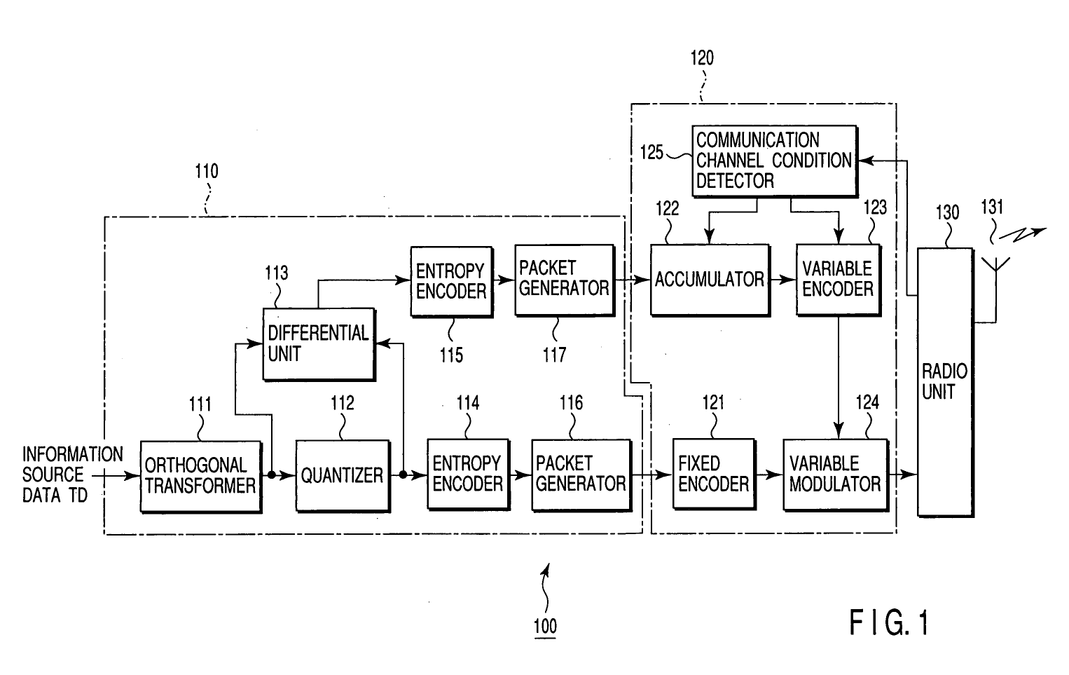

FIG. 1 is a block diagram showing a main structure of a transmission device according to the first embodiment of the invention. The transmission device 100 comprises an information source encoding unit 110, an adaptive transmission unit 120 and a radio unit 130.

The information source encoding unit 110 includes an orthogonal transformer 111, a quantizer 112, a differential unit 113, first and second entropy encoders 114 and 115, and first and second packet generators 116 and 117. The orthogonal transformer 111 comprises a lossless transformer that can completely reproduce original information without loss. The orthogonal transformer 111 converts input information source data TD from a time-axis signal to a frequency-axis signal. A lossless wavelet transformer used in JPEG (Joint Photographic Experts Group) 2000 or a lossless discrete cosine transform (DCT) unit, for instance, is used as the lossless orthogonal transformer 111.

The quantizer 112 quantizes an orthogonal-transformed output of information source data TD, which is output from the orthogonal transformer 111. The first entropy encoder 114 entropy-encodes the quantized output of the quantizer 112, that is, the first information component necessary for real-time reproduction, and outputs compressed first encoded information data. A lossless information compressor, such as a Huffman encoder or an arithmetic encoder, is used as the first entropy encoder 114. The first packet generator 116 packetizes the first encoded information data output from the first entropy encoder 114, with each packet having a proper bit length. The first packet generator 116 delivers the packet of the first encoded information data to the adaptive transmission unit 120.

The differential unit 113 finds a difference between the orthogonal-transformed output of the orthogonal transformer 111 and the quantized output of the quantizer 112, that is, a second information component which has been lost when the orthogonal-transformed output was quantized by the quantizer 112. The second entropy encoder 115 entropy-encodes the second information component extracted by the differential unit 113 and produces compressed second encoded information data. The second packet generator 117 packetizes the second encoded information data output from the second entropy encoder 115, with each packet having a proper bit length. The second packet generator 117 delivers the packet of the second encoded information data to the adaptive transmission unit 120.

The adaptive transmission unit 120 includes a fixed encoder 121, an accumulator 122, a variable encoder 123, a variable modulator 124, and a communication channel condition detector 125. The fixed encoder 121 subjects the packet of the first encoded information data output from the first packet generator 116 to an error correction encoding with a fixed encoding ratio. Thereby, the fixed encoder 121 generates a first packet which has been subjected to the error correction encoding. For example, an error correction encoding with an encoding ratio R=1/3 is performed. The encoding ratio R is defined by an information bit number/(information bit+parity bit).

The accumulator 122 is used as a buffer for a variable encoding process. The accumulator 122 temporarily stores the packet of the second encoded information data, which has been output from the second packet generator 117. The variable encoder 123 comprises an encoder with a variable encoding ratio R. The variable encoder 123 subjects the second packet read out of the accumulator 122 to an error correction encoding according to the encoding ratio R designated by the communication channel condition detector 125 (to be described later). Settable encoding ratios R are, for instance, R=1/2 and R=1/2.

The variable modulator 124 has, e.g. three modulation schemes: 4PSK (Phase Shift Keying), 16QAM (Quadrature Amplitude Modulation), and 64QAM. Of these modulation schemes, the modulation scheme designated by the communication channel condition detector 125 (to be described later) is used to convert the first packet output from the fixed encoder 121 and the second packet output from the variable encoder 123 to a modulated signal.

The communication channel condition detector 125 detects at least one of the reception electric field intensity and the error ratio of a radio signal received by the radio unit 130, and compares the detected value with a threshold value, thereby determining the transmission quality of the wireless communication channel. Based on the determination result, the optimal encoding ratio R and modulation scheme at each point in time are selected. The selected encoding ratio R and modulation scheme are set in the variable encoder 123 and variable modulator 124.

The radio unit 130 frequency-converts the modulated signal output from the variable modulator 124 to a radio-frequency signal, amplifies the frequency-converted signal up to an optimal transmission power level, and transmits the amplified radio signal to the wireless communication channel via a transmission antenna 131.

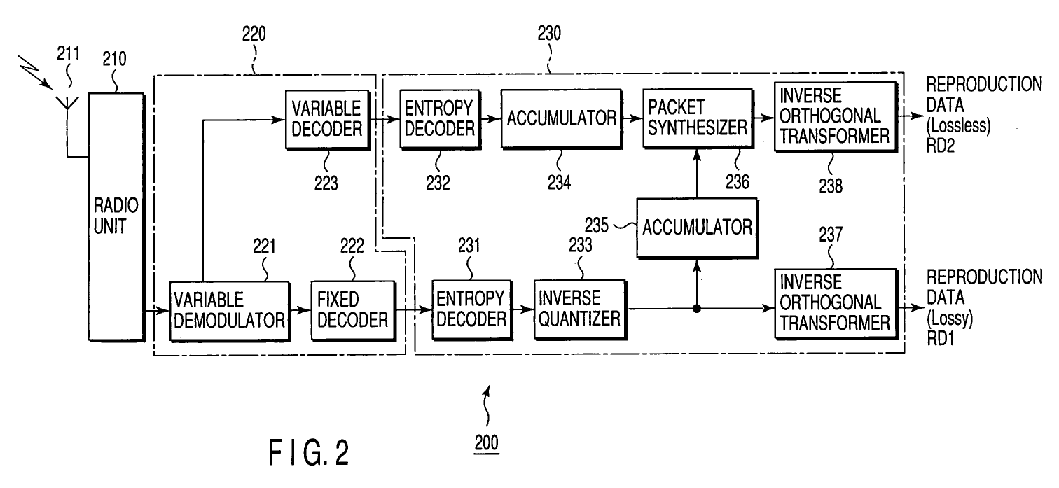

On the other hand, the receiving device according to the first embodiment of the invention is constructed as described below. FIG. 2 is a block diagram showing the main structure of the receiving device. The receiving device 200 comprises a radio unit 210, an adaptive reception unit 220, and an information source decoding unit 230.

The radio unit 210 amplifies the radio signal received by a reception antenna 211, frequency-converts the amplified signal to an intermediate-frequency or a base-band frequency reception signal, and inputs the reception signal to the adaptive reception unit 220.

The adaptive reception unit 220 includes a variable demodulator 221, a fixed decoder 222, and a variable decoder 223. The variable demodulator 221 selects a demodulation scheme corresponding to the modulation scheme used in the transmission device 100, for example, 4PSK, 16QAM or 64QAM. According to the selected demodulation scheme, the variable demodulator 221 demodulates the reception signal. The variable demodulator 221 inputs first demodulated data corresponding to the first packet to the fixed decoder 222, and second demodulated data corresponding to the second packet to the variable decoder 223.

The fixed decoder 222 subjects the input first demodulated data to an error correction decoding process according to a fixed encoding ratio R (e.g. R=1/3). The fixed decoder 222 delivers first decoded data, which has been subjected to the error correction decoding, to a first entropy decoder 231 of the information source decoding unit 230. The variable decoder 223 comprises an error correction decoder capable of variable-setting the encoding ratio R. The variable decoder 223 subjects the input second demodulated data to an error correction decoding process according to the encoding ratio R used in the transmission device 100. The variable decoder 223 delivers second decoded data, which has been subjected to the error correction decoding, to a second entropy decoder 232 of the information source decoder 230. Settable encoding ratios R are, for instance, R=1/2 and R=2/3.

The information source decoding unit 230 includes first and second entropy decoders 231 and 232, an inverse quantizer 233, accumulators 234 and 235, a packet synthesizer 236, and first and second inverse orthogonal transformers 237 and 238.

The first entropy decoder 231 entropy-decodes the first decoded data output from the fixed decoder 222. The inverse quantizer 233 subjects the decoded packet output from the first entropy decoder 231 to an inverse quantization process, and produces decoded packet data corresponding to the first information component. The inverse orthogonal transformer 237 subjects the decoded packet data output from the inverse quantizer 233 to an inverse orthogonal transform, thereby converting the decoded packet data from a frequency-axis signal to a time-axis signal. The inverse-orthogonal-transformed reproduction data RD1 is reproduced by a reproduction unit (not shown). The reproduction data RD1 can be reproduced in real time, but it is lossy data.

The second entropy decoder 232 entropy-decodes the second decoded packet output from the variable decoder 223. The accumulator 234 has a buffer function for a packet synthesis process (to be described later), and temporarily stores the decoded packet data output from the second entropy decoder 232. The accumulator 235 temporarily stores the real-time decoded packet data output from the inverse quantizer 233.

The packet synthesizer 236 reads out the decoded packet data from each accumulator 233, 234, establishes temporal correspondence between the read-out decoded packet data components based on the attached timestamps, and synthesizes these packet data components. The second inverse orthogonal transformer 238 converts the packet data synthesized by the packet synthesizer 236 from a frequency-axis signal to a time-axis signal, thereby generating reproduction data RD2 and outputting the reproduction data RD2 to the reproduction unit (not shown).

The reproduction unit stores the reproduction data RD2 in a storage medium such as a hard disk or an external memory card. The reproduction unit reproduces and outputs the reproduction data upon the user's reproduction instruction operation. The reproduction data RD2 is not capable of real-time reproduction, but it is lossless data that permits complete reproduction of the original data without loss.

The operations of the transmission device 100 and receiving device 200 having the above-described structures will now be described.

Information source data TD is output from the information source (not shown) to the transmission device 100. The information source data TD is orthogonal-transformed by the orthogonal transformer 111, and then quantized by the quantizer 112, and further encoded by the first entropy encoder 114.

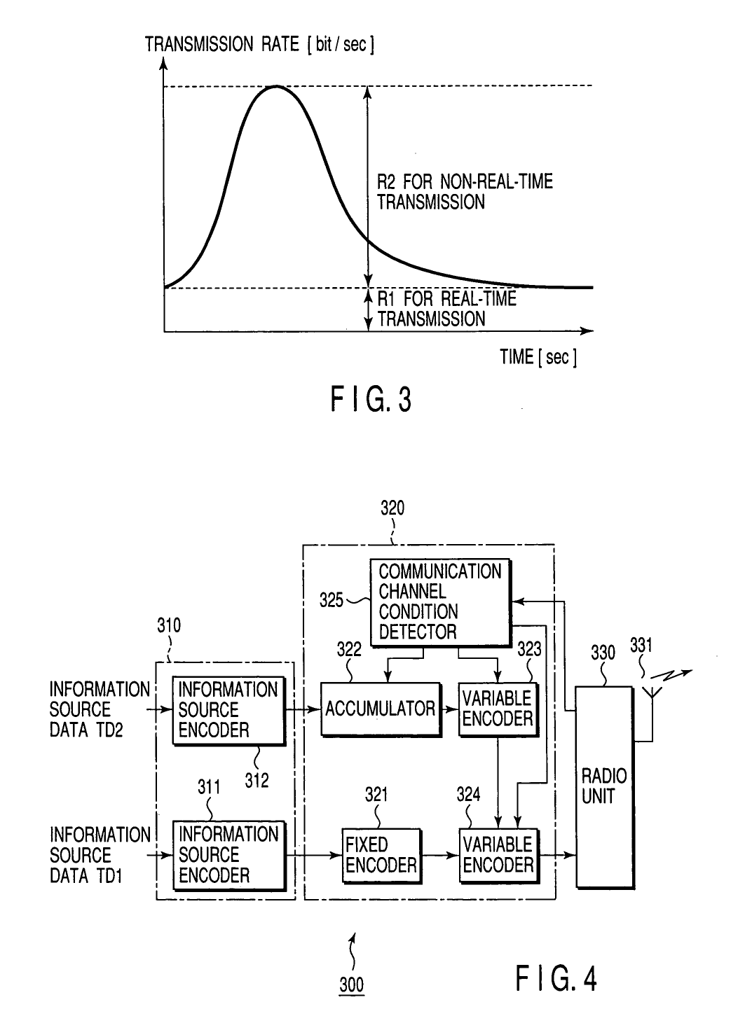

The encoding rate for the quantization and the first entropy encoder 114 are set according to the transmission characteristics of the wireless communication channel in the following manner. The transmission rate of the wireless communication channel varies depending on the transmission quality. Even in this condition, there is a minimum transmission rate that can always be secured. FIG. 3 illustrates an example of the transmission rate. Even when the transmission quality is very poor, a first transmission rate R1 can be secured. When the transmission quality is good, a second transmission rate R2 can be secured.

The encoding rate for the quantization and the first entropy encoder 114 are set to correspond to the first transmission rate R1. As a result, by the information compression by the quantization and the first entropy encoding, encoded information data capable of real-time transmission is generated at the first transmission rate R1 over the wireless communication channel.

The encoded information data generated by the first entropy encoder 114 is packetized by the first packet generator 116. The packetized data is error-correction-encoded by the fixed encoder 121 at the preset fixed encoding rate R (e.g. R=1/3) and then input to the variable modulator 124.

On the other hand, the differential unit 113 extracts the difference between the orthogonal transform output of the orthogonal transformer 111 and the quantized output of the quantizer 112, that is, the information component that has been lost when the orthogonal transform output was quantized by the quantizer 112. The extracted information component is encoded by the second entropy encoder 115 and packetized by the second packet generator 117. The packetized data is temporarily stored in the accumulator 122. Then, the packetized data is subjected to an error correction encoding by the variable encoder 123, and is input to the variable modulator 124 as second packet data. The variable modulator 124 generates a modulated signal corresponding to the first packet data output from the fixed encoder 121 and the second packet data output from the variable encoder 123.

The error correction encoding process in the variable encoder 123 and the variable adaptive modulation process in the variable modulator 124 are controlled by the communication channel condition detector 125 in the following manner.

The communication channel condition detector 125 compares the reception electric field intensity or the error ratio of the reception signal with first and second thresholds. Thereby, the communication channel condition detector 125 determines the transmission quality of the wireless communication channel. Assume that the result of the determination indicates that the transmission quality is very poor and lower than the first threshold. In this case, the communication channel condition detector 125 determines that transmission of the second packet data is impossible, and sets 4PSK in the variable modulator 124, without activating the accumulator 122 and variable encoder 123. The input bit number of the 4PSK is 2 bits. The variable modulator 124 effects modulation by inputting the first packet data output from the fixed encoder 121 to all the bits (2 bits) of the 4PSK. Thus, the 4PSK modulated signal modulated with the first packet data is transmitted to the wireless communication channel.

On the other hand, assume that the result of the determination shows that the transmission quality of the wireless communication channel is not less than the first threshold and less than the second threshold. In this case, the communication channel condition detector 125 determines that the transmission quality poor but the second packet data can be transmitted. The communication channel condition detector 125 sets an encoding ratio R=1/2 in the variable encoder 123, and reads out of the accumulator 122 the second packet data in the amount corresponding to the encoding ratio R=1/2. As a result, the second packet data read out of the accumulator 122 is subjected to error correction encoding at the encoding ratio R=1/2 in the variable encoder 123.

In addition, the communication channel condition detector 125 sets 16QAM in the variable modulator 124. The input bit number of the 16QAM is 4 bits. The variable modulator 124 inputs the first packet data output from the fixed encoder 121 to the MSB (Most Significant Bit)-side two bits of the four input bits of the 16QAM. Moreover, the variable modulator 124 inputs the second packet data output from the variable encoder 123 to the LSB (Least Significant Bit)-side two bits. The variable modulator 124 performs the 16QAM for the input first and second packet data. Accordingly, a 16QAM modulated signal that is modulated with the first and second packet data is transmitted to the wireless communication channel. Then, assume that the transmission quality of the wireless communication channel has recovered up to the second threshold or above. In this case, the communication channel condition detector 125 determines that the transmission quality is good, and sets an encoding ratio R=2/3 in the variable encoder 123 and reads out of the accumulator 122 the second packet data in the amount corresponding to the encoding ratio R=2/3. As a result, the second packet data read out of the accumulator 122 is subjected to error correction encoding at the encoding ratio R=2/3 in the variable encoder 123.

In addition, the communication channel condition detector 125 sets 64QAM in the variable modulator 124. The input bit number of the 64QAM is 6 bits. The variable modulator 124 inputs the first packet data output from the fixed encoder 121 to the MSB (Most Significant Bit)-side two bits of the six input bits of the 64QAM. Moreover, the variable modulator 124 inputs the second packet data output from the variable encoder 123 to the LSB (Least Significant Bit)-side four bits. The variable modulator 124 performs the 64QAM for the input first and second packet data. Accordingly, a 64QAM modulated signal that is modulated with the first and second packet data is transmitted to the wireless communication channel.

On the other hand, the receiving device 200 performs the following demodulation/decoding process.

The radio signal coming from the transmission device 100 via the wireless communication channel is received by the radio unit 210 and input to the adaptive reception unit 220. In the adaptive reception unit 220, the variable demodulator 221 subjects the reception signal to a variable demodulation process. The variable demodulation process determines the modulation scheme that is applied to the reception signal. Thus, a demodulation scheme corresponding to the determined modulation scheme is set, and the reception signal is demodulated according to the set demodulation scheme.

For example, in the case where the transmission quality of the wireless communication channel is very poor and the 4PSK is used as the modulation scheme, the reception signal is demodulated by the demodulation scheme corresponding to the 4PSK. In the state in which the 4PSK is used, all bits of the two-bit demodulation output are demodulation data corresponding to the first packet data. Thus, the two-bit demodulation data is input to the fixed decoder 222. In the fixed decoder 222, the error correction decoding process for the demodulation data is executed at the preset fixed encoding ratio R=1/3.

The demodulation data, which has been subjected to the error correction decoding, is decoded by the first entropy decoder 231 of the information source decoding unit 230. Further, the decoded data is inverse-quantized by the inverse quantizer 233 and thus decoded to the pre-compression packet data. The decoded first packet data is de-packetized and inverse-orthogonal-transformed by the inverse orthogonal transformer 237. Thereby, the data is restored to the time-axis reproduction data RD1. The time-axis reproduction data RD1 is supplied to the reproduction unit (not shown) and reproduced. Therefore, the first packet data is reproduced in real time, although this data is lossy. The first packet data decoded by the inverse quantizer 233 is accumulated in the accumulator 235 so that it may be used for a lossless reproduction process (to be described later).

On the other hand, in the case where the transmission quality of the wireless communication channel is relatively poor, the 16QAM is used as the modulation scheme. Thus, the variable demodulator 221 demodulates the reception signal by the demodulation scheme corresponding to the 16QAM. In the state in which the 16QAM is used, the MSB-side two bits of the 4-bit demodulation output are demodulation data corresponding to the first packet data, and the LSB-side two bits are demodulation data corresponding to the second packet data. Accordingly, the demodulation data of the MSB-side-two bits is input to the fixed decoder 222, and the demodulation data of the LSB-side two bits is input to the variable decoder 223.

In the fixed decoder 222, the error correction decoding process for the demodulation data is executed at the preset fixed encoding ratio R=1/3. The demodulation data, which has been subjected to the error correction decoding, is decoded by the first entropy decoder 231 of the information source decoding unit 230. Further, the decoded data is inverse-quantized by the inverse quantizer 233 and thus decoded to the pre-compression packet data. The decoded first packet data is de-packetized and inverse-orthogonal-transformed by the inverse orthogonal transformer 237. Thereby, the data is restored to the time-axis reproduction data RD1. The time-axis reproduction data RD1 is supplied to the reproduction unit (not shown) and reproduced. That is, the time-axis reproduction data RD1 is reproduced in real time.

On the other hand, the encoding ratio R=1/2 is set in the variable decoder 223 according to the control information told from the transmission device 100. The variable decoder 223 performs the error correction decoding process for the demodulation data on the basis of the encoding ratio R=1/2 that is set. The error-correction-decoded demodulation data is entropy-decoded by the second entropy decoder 232 of the information source decoding unit 230, and the entropy-decoded result is accumulated in the accumulator 234.

If a predetermined amount of the decoded second packet data is accumulated in the accumulator 234, the decoded second packet data is read out of the accumulator 234 and input to the packet synthesizer 236. At the same time, the inverse-quantized first packet data is read out of the accumulator 235 and input to the packet synthesizer 236. The packet synthesizer 236 synthesizes the read-out first and second packet data, which corresponds in time, on the basis of the timestamps. The synthesized decoded packet data is de-packetized and inverse-orthogonal-transformed by the inverse orthogonal transformer 238. Thereby, the data is restored to the time-axis reproduction data RD2. The time-axis reproduction data RD2 is supplied to the reproduction unit (not shown).

The reproduction unit stores the reproduction data RD2 in a storage medium such as a hard disk or an external memory card. The reproduction unit reproduces and outputs the reproduction data upon the user's reproduction instruction operation. The synthesized packet data corresponds to the information source data TD input to the information source encoding unit 110 of the transmission device 100. Therefore, the reproduction unit can reproduce lossless information data, although this data is not capable of real-time reproduction.

In the state in which the transmission quality of the wireless communication channel is good, the 64QAM is used as the modulation scheme. Thus, the variable demodulator 221 demodulates the reception signal by the demodulation scheme corresponding to the 64QAM. In the state in which the 64QAM is used, the MSB-side two bits of the 6-bit demodulation output are demodulation data corresponding to the first packet data, and the LSB-side four bits are demodulation data corresponding to the second packet data. Accordingly, the demodulation data of the MSB-side two bits is input to the fixed decoder 222, and the demodulation data of the LSB-side four bits is input to the variable decoder 223.

As has been described above, in the fixed decoder 222, the error correction decoding process for the demodulation data is executed at the preset fixed encoding ratio R=1/3. The demodulation data, which has been subjected to the error correction decoding, is decoded by the first entropy decoder 231 of the information source decoding unit 230. Further, the decoded data is inverse-quantized by the inverse quantizer 233 and thus decoded to the pre-compression packet data. The decoded first packet data is de-packetized and inverse-orthogonal-transformed by the inverse orthogonal transformer 237. Thereby, the data is restored to the time-axis reproduction data RD1. The time-axis reproduction data RD1 is supplied to the reproduction unit (not shown) and reproduced. That is, the time-axis reproduction data RD1 is reproduced in real time.

On the other hand, the encoding ratio R=2/3 is set in the variable decoder 223 according to the control information told from the transmission device 100. The variable decoder 223 performs the error correction decoding process for the demodulation data on the basis of the encoding ratio R=2/3 that is set. The error-correction-decoded demodulation data is entropy-decoded by the second entropy decoder 232 of the information source decoder 230, and the entropy-decoded result is accumulated in the accumulator 234.

If a predetermined amount of the decoded second packet data is accumulated in the accumulator 234, the packet synthesizer 236 synthesizes the first and second packet data, which is read out of the accumulators 235 and 234 and corresponds in time, on the basis of the timestamps. The synthesized decoded packet data is de-packetized and transformed to time-axis reproduction data RD2 by the inverse orthogonal transformer 238. Then, the time-axis reproduction data RD2 is supplied to the reproduction unit (not shown).

According to the present embodiment, as described above, in the transmission device 100, the information source data TD, which is the object of transmission, is separated into the first information data necessary for the real-time reproduction and the other second information data necessary for lossless reproduction by the quantizer 112 and differential unit 113. The first information data and second information data is wirelessly transmitted using, respectively, a first transmission rate R1 that is always secured on the wireless communication channel and a second transmission rate R2 that is irregularly secured when the transmission quality is good. In the receiving device 200, decoded data corresponding to the first information data is reproduced in real time and stored in the accumulator 235. In addition, the stored first information data and the decoded data corresponding to the second information data are made to have temporal correspondency and then synthesized by the packet synthesizer 236. Thereby, the information source data TD, which is the object of transmission, is losslessly reproduced.

Accordingly, of the information source data TD that is the object of transmission, the first information data, which is necessary for real-time reproduction, is transmitted and reproduced in real time using the first transmission rate R1 that is always secured on the communication channel. In parallel with this, the second information data, which is necessary for lossless reproduction, can be transmitted using the second transmission rate R2 that is irregularly secured when the transmission quality is good, and the original information data can be synthesized. Thus, information data, such as motion picture data and audio data, whose generated information amount varies with time, can be transmitted using a wireless communication channel whose transmission quality varies with time, in the state in which both real-time reproduction and lossless reproduction are maintained.

The use of the above structure realizes, for example, the following applications of the data transmission apparatus. In a case where caring and nursing services are offered through the use of TV telephone communication, real-time TV telephony is conducted with the recipient of care or patient, following which the complexion or condition of the recipient of care or patient can be understood in detail based on the subsequently losslessly reproduced high-definition images. In addition, in a remote-observation system for observing rivers, etc., the supervisor can monitor the general states of rivers, etc. in real time and, if abnormality is discovered, he/she can conduct a further detailed study of the rivers, etc. on the basis of high-definition motion picture which is losslessly reproduced subsequently. Furthermore, when motion picture or audio data is delivered with payment, low-resolution video data, low-sound-quality audio data, or audio data of either a right or left channel is transmitted in real time so that the user may view/listen to it on a trial basis. If the user agrees with payment, high-resolution video data, high-sound-quality audio data, or audio data of plural channels may be reproduced in a lossless mode.

### SECOND EMBODIMENT

In a second embodiment of the present invention, the transmission device transmits first information source data that requires real-time reproduction and second information source data that does not require real-time reproduction, using a first transmission rate that can always be secured on the wireless communication channel and a second transmission rate that can irregularly be set when the transmission quality is good. In the receiving device, demodulation data corresponding to the first information data is decoded and reproduced in real time, while demodulation data corresponding to the second information data is once accumulated and then decoded and reproduced.

FIG. 4 is a block diagram showing a main structure of the transmission device according to the second embodiment of the present invention. The transmission device 300 includes an information source encoding unit 310, an adaptive transmission unit 320 and a radio unit 330.

The information source encoding unit 310 includes a first information source encoder 311 and a second information source encoder 312. The first information source encoder 311 comprises an encoder for lossy information, which encodes information source data TD1 output from an information source (not shown) and requires real-time reproduction. The second information source encoder 312 comprises an encoder for lossless information, which encodes information source data TD1 output from the information source (not shown) and does not require real-time reproduction.

The adaptive transmission unit 320 includes a fixed encoder 321, an accumulator 322, a variable encoder 323, a variable modulator 324 and a communication channel condition detector 325. The fixed encoder 321 error-correction-encodes first encoded information data output from the first information source encoder 311, using a preset encoding ratio. The fixed encoder 321 delivers the resultant encoded data to the variable modulator 324. The accumulator 322 temporarily accumulates second encoded information data output from the second information source encoder 312 for the purpose of adaptive encoding/modulation processing.

The variable encoder 323 error-correction-encodes the second information data, selectively using one of a plurality of encoding ratios. The variable encoder 323 delivers the output data to the variable modulator 324. Two encoding ratios, e.g. R=1/2 and R=2/3, are usable. The variable modulator 324 converts the first and second encoded data to a modulated signal, selectively using one of a plurality of modulation schemes. The variable modulator 324 inputs the modulated signal to the radio unit 330. Three modulation schemes, e.g. 4PSK, 16QAM and 64QAM, are usable.

The communication channel condition detector 325 detects at least one of the reception electric field intensity and the error ratio of a radio signal received by the radio unit 330, and compares the detected value with a threshold, thereby determining the transmission quality of the wireless communication channel. Based on the determination result, the optimal encoding ratio R and modulation scheme at each point in time are selected. The selected encoding ratio R and modulation scheme are set in the variable encoder 323 and variable modulator 324.

The radio unit 330 frequency-converts the modulated signal output from the variable modulator 324 to a radio-frequency signal, amplifies the frequency-converted signal up to an optimal transmission power level, and transmits the amplified radio signal to the wireless communication channel via a transmission antenna 331.

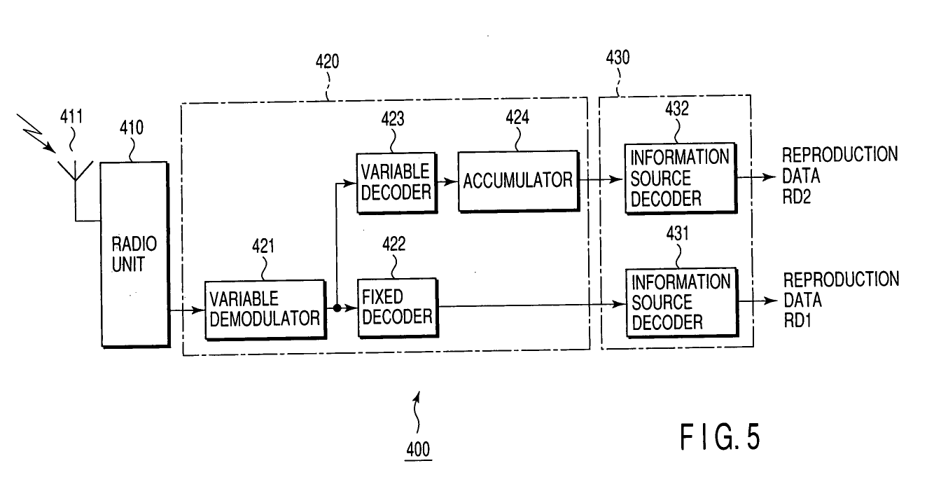

The receiving device according to the second embodiment of the present invention is constructed as follows. FIG. 5 is a block diagram showing a main structure of the receiving device. The receiving device 400 comprises a radio unit 410, an adaptive reception unit 420 and an information source decoding unit 430.

The radio unit 410 amplifies a radio signal received by a reception antenna 411, and frequency-converts the amplified signal to a reception signal with an intermediate frequency or a base-band frequency. The radio unit 410 inputs the reception signal to the adaptive reception unit 420.

The adaptive reception unit 420 includes a variable demodulator 421, a fixed decoder 422, a variable decoder 423 and an accumulator 424. The variable demodulator 421 selects a demodulation scheme used in the transmission device 300, for example, a demodulation scheme corresponding to 4PSK, 16QAM or 64QAM. According to the selected demodulation scheme, the variable demodulator 421 demodulates the reception signal. The variable demodulator 421 inputs first demodulated data corresponding to the first information source data TD1 to the fixed decoder 422, and second demodulated data corresponding to the second information source data TD2 to the variable decoder 423.

The fixed decoder 422 subjects the input first demodulated data to an error correction decoding process according to a fixed encoding ratio R (e.g. R=1/3). The variable decoder 423 comprises an error correction decoder capable of variable-setting the encoding ratio R. The variable decoder 423 subjects the input second demodulated data to an error correction decoding process according to the encoding ratio R used in the transmission device 300. Settable encoding ratios R are, for instance, R=1/2 and R=1/2.

The information source decoding unit 430 includes a first information source decoder 431 and a second information source decoder 432. The first information source decoder 431 comprises a lossy decoder, which decodes first decoded data that is subjected to the error correction decoding and is output from the fixed decoder 422. The first information source decoder 431 supplies the decoded reproduction data RD1 to the reproduction unit (not shown). The second information source decoder 432 is a lossless decoder. The second information decoder 432 decodes second decoded data read out of the accumulator 424, and supplies the decoded reproduction data RD2 to the reproduction unit (not shown).

The operations of the transmission device 300 and receiving device 400 with the above structures will now be described.

In the transmission device 300, when first information source data TD1 that requires real-time transmission is input to the information encoding unit 310, the first information source encoder 311 encodes the first information source data TD1 according to a lossy encoding scheme. Then, the fixed encoder 321 error-correction-encodes the encoded data with a fixed encoding ratio R=1/3. The error-correction-encoded first information data is input to the variable modulator 324. The encoding ratio R is set to correspond to a minimum securable transmission rate (e.g. R1 in FIG. 3) that can always be secured on the wireless communication channel.

On the other hand, when second information source data TD2 that does not require real-time transmission is input to the information encoding unit 310, the second information source encoder 312 encodes the second information source data TD2 according to a lossless encoding scheme. The encoded data is temporarily stored in the accumulator 322. The stored data is read out during a time period in which the transmission quality is good, and the read-out data is subjected to error correction encoding by the variable encoder 323 and is input to the variable modulator 324. The variable modulator 324 converts the first encoded data output from the fixed encoder 321 and the second encoded data output from the variable encoder 323 to a modulated signal. The modulated signal is sent to the wireless communication channel from the radio unit 330.

The adaptive encoding process in the variable encoder 323 and the adaptive modulation process in the variable modulator 324 are controlled by the communication channel condition detector 325 in the following manner.

Specifically, the communication channel condition detector 325 compares the reception electric field intensity or error ratio of the reception signal with first and second thresholds. Thereby, the communication channel condition detector 325 determines the transmission quality of the wireless communication channel. Assume that the result of the determination indicates that the transmission quality is very poor and lower than the first threshold. In this case, the communication channel condition detector 325 determines that transmission of the second information source data TD2 is impossible, and sets 4PSK in the variable modulator 324, without activating the accumulator 322 and variable encoder 323. The input bit number of the 4PSK is 2 bits. The variable modulator 324 effects modulation by inputting the first encoded data output from the fixed encoder 321 to all the bits (2 bits) of the 4PSK. Thus, the 4PSK modulated signal modulated with only the first encoded data is transmitted to the wireless communication channel.

On the other hand, assume that the result of the determination shows that the transmission quality of the wireless communication channel is not less than the first threshold and less than the second threshold. In this case, the communication channel condition detector 325 determines that the transmission quality is poor but the second encoded data can be transmitted. The communication channel condition detector 325 sets an encoding ratio R=1/2 in the variable encoder 323, and reads out of the accumulator 322 the second encoded data in the amount corresponding to the encoding ratio R=1/2. As a result, the second encoded data read out of the accumulator 322 is error-correction-encoded at the encoding ratio R=1/2 in the variable encoder 323.

In addition, the communication channel condition detector 325 sets 16QAM in the variable modulator 324. The input bit number of the 16QAM is 4 bits. The variable modulator 324 inputs the first encoded data output from the fixed encoder 321 to the MSB-side two bits of the four input bits of the 16QAM. Moreover, the variable modulator 324 inputs the second encoded data output from the variable encoder 323 to the LSB-side two bits. The variable modulator 324 performs the 16QAM for the input first and second encoded data. Accordingly, the 16QAM modulated signal that is modulated with the first and second encoded data is transmitted to the wireless communication channel.

Then, assume that the transmission quality of the wireless communication channel has recovered up to the second threshold or above. In this case, the communication channel condition detector 325 determines that the transmission quality is good, and sets an encoding ratio R=2/3 in the variable encoder 323 and reads out of the accumulator 322 the second encoded data in the amount corresponding to the encoding ratio R=2/3. As a result, the second encoded data read out of the accumulator 322 is subjected to error correction encoding at the encoding ratio R=2/3 in the variable encoder 323.

In addition, the communication channel condition detector 325 sets 64QAM in the variable modulator 324. The input bit number of the 64QAM is 6 bits. The variable modulator 324 inputs the first encoded data output from the fixed encoder 321 to the MSB-side two bits of the six input bits of the 64QAM. Moreover, the variable modulator 324 inputs the second encoded data output from the variable encoder 323 to the LSB-side four bits. The variable modulator 324 performs the 64QAM for the input first and second encoded data. Accordingly, the 64QAM modulated signal that is modulated by the first and second encoded data is transmitted to the wireless communication channel.

On the other hand, the receiving device 400 performs the following demodulation/decoding process.

The radio signal coming from the transmission device 300 via the wireless communication channel is received by the radio unit 410 and input to the adaptive reception unit 420. In the adaptive reception unit 420, the variable demodulator 421 subjects the reception signal to a variable demodulation process. The variable demodulation process determines the modulation scheme that is applied to the reception signal. Thus, the demodulation scheme corresponding to the determined modulation scheme is set, and the reception signal is demodulated according to the set demodulation scheme.

For example, in the case where the transmission quality of the wireless communication channel is very poor and the 4PSK is used as the modulation scheme, the reception signal is demodulated by the demodulation scheme corresponding to the 4PSK. In the state in which the 4PSK is used, all bits of the two-bit demodulation output are demodulation data corresponding to the first encoded data. Thus, the two-bit demodulation data is input to the fixed decoder 422. In the fixed decoder 422, the error correction decoding process for the demodulation data is executed at the preset fixed encoding ratio R=1/3.

The demodulation data, which has been subjected to the error correction decoding, is decoded into first reproduction data RD1 by the first information source decoder 431. The first reproduction data RD1 is supplied to the reproduction unit (not shown) and reproduced. Therefore, the first information source data TD1 is reproduced in real time, although this data is lossy.

On the other hand, in the case where the transmission quality of the wireless communication channel is relatively poor, the 16QAM is used as the modulation scheme. Thus, the variable demodulator 421 demodulates the reception signal by the demodulation scheme corresponding to the 16QAM. In the state in which the 16QAM is used, the MSB-side two bits of the 4-bit demodulation output are demodulation data corresponding to the first encoded data, and the LSB-side two bits are demodulation data corresponding to the second encoded data. Accordingly, the demodulation data of the MSB-side two bits is input to the fixed decoder 422, and the demodulation data of the LSB-side two bits is input to the variable decoder 423.

In the fixed decoder 422, the error correction decoding process for the demodulation data is executed at the preset fixed encoding ratio R=1/3. The demodulation data, which has been subjected to the error correction decoding, is decoded into first reproduction data RD1 by the information source decoder 431. The first reproduction data RD1 is supplied to the reproduction unit (not shown) and reproduced. That is, the first reproduction data RD1 is reproduced in real time.

On the other hand, the encoding ratio R=1/2 is set in the variable decoder 423 according to the control information told from the transmission device 300. The variable decoder 423 performs the error correction decoding process for the demodulation data on the basis of the encoding ratio R=1/2 that is set. The error-correction-decoded demodulation data is temporarily stored in the accumulator 424 and synthesized with preceding and subsequent reception data in the accumulator 424. Thus, the original information data is restored. The restored information data is output to the reproduction unit (not shown) and reproduced.

In the state in which the transmission quality of the wireless communication channel is good, the 64QAM is used as the modulation scheme. Thus, the variable demodulator 421 demodulates the reception signal by the demodulation scheme corresponding to the 64QAM. In the state in which the 64QAM is used, the MSB-side two bits of the 6-bit demodulation output are demodulation data corresponding to the first encoded data, and the LSB-side four bits are demodulation data corresponding to the second encoded data. Accordingly, the demodulation data of the MSB-side two bits is input to the fixed decoder 422, and the demodulation data of the LSB-side four bits is input to the variable decoder 423.

As has been described above, in the fixed decoder 422, the error correction decoding process for the demodulation data is executed at the preset fixed encoding ratio R=1/3. The demodulation data, which has been subjected to the error correction decoding, is decoded by the first information source decoder 431. The decoded data is supplied to the reproduction unit (not shown) and reproduced. That is, the decoded data is reproduced in real time.

On the other hand, the encoding ratio R=2/3 is set in the variable decoder 423 according to the control information told from the transmission device 300. The variable decoder 423 performs the error correction decoding process for the demodulation data on the basis of the encoding ratio R=2/3 that is set. The error-correction-decoded demodulation data is temporarily stored in the accumulator 424 and synthesized with preceding and subsequent reception data in the accumulator 424. Thus, the original information data is restored. The restored information data is output to the reproduction unit (not shown).

As has been described above, according to the second embodiment, the transmission device 300 transmits first information source data that requires real-time reproduction and second information source data that does not require real-time reproduction, using a first transmission rate R1 that can always be secured on the wireless communication channel and a second transmission rate R2 that can irregularly be set when the transmission quality is good. In the receiving device 400, demodulation data corresponding to the first information data TD1 is decoded and reproduced in real time, while demodulation data corresponding to the second information data TD2 is accumulated and reconstructed in the accumulator 424, and then the resultant data is decoded and reproduced.

Therefore, the first information source data TD1 that requires real-time reproduction and the second information source data TD2 that does not require real-time reproduction can be transmitted in parallel over the wireless communication channel having a transmission quality that varies with time. Hence, high-efficiency transmission is achieved, compared to the case where the first information source data TD1 and second information source data TD2 are transmitted using different communication channels or transmitted over a single communication channel in a time-division manner.

### THIRD EMBODIMENT

An output (±6 or ±2, ±6j or ±2j) of a 16QAM modulator is regarded as an output obtained by adding an output (±2, ±2j) of a 4PSK modulator to an output (±4, ±4j) of a 4PSK modulator. Similarly, an output (±7 or ±5 or ±3 or ±1, ±7j or ±5j or ±3j or ±1j) of a 64QAM modulator is regarded as an output obtained by adding an output (±3 or ±1, ±3j or ±1j) of a 16QAM modulator to an output (±4, ±4j) of a 4PSK modulator.

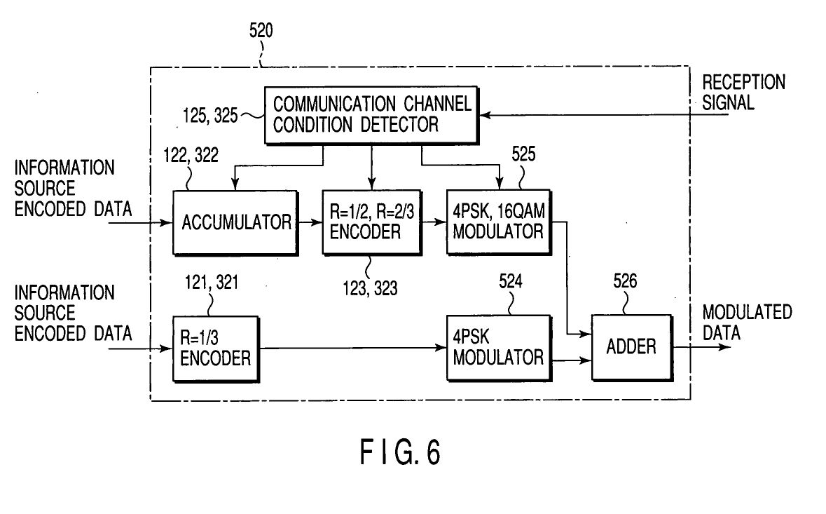

In a third embodiment of the present invention, attention is paid to this fact, and the structure of the variable modulator in the adaptive transmission unit is improved. FIG. 6 shows an example of the structure. In FIG. 6, the parts common to those in FIGS. 1 and 3 are denoted by like reference numerals.

In FIG. 6, an adaptive transmission unit 520 includes a 4PSK modulator 524 that produces a 4PSK output (±4, ±4j), a variable modulator 525 that produces a 4PSK output (±2, ±2j) or a 16QAM output (±3 or ±1, ±3j or ±1j), and an adder 526. The modulated output of the variable modulator 525 and the modulated output of the 4PSK modulator 524 are added by the adder 526, thereby obtaining an output (±6 or ±2, ±6j or ±2j) of a 16QAM modulator and an output (±7 or ±5 or ±3 or ±1, ±7j or ±5j or ±3j or ±1j) of a 64QAM modulator.

By virtue of this structure, a 64QAM modulator becomes needless when variable modulators are constructed. Therefore, the circuitry structure of the variable modulators can be simplified.

### FOURTH EMBODIMENT

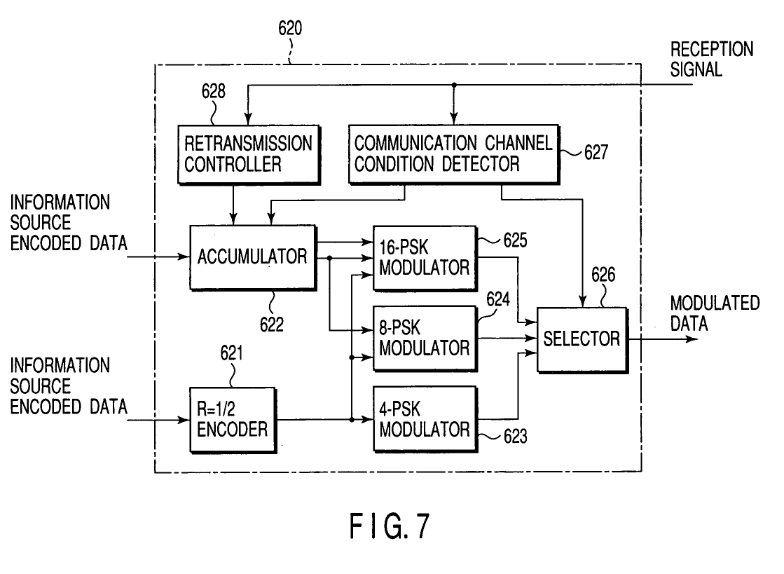

Alternatively, the adaptive transmission unit in the transmission device may adopt a structure described below. FIG. 7 is a block diagram showing this structure.

An adaptive transmission unit 620 according to a fourth embodiment of the invention includes a fixed encoder 621 with an encoding ratio R=1/2, an accumulator 622, a communication channel condition detector 627, a retransmission controller 628, and variable modulators. The variable modulators comprise a 4PSK modulator 623, an 8PSK modulator 624, a 16PSK modulator 625, and a selector 626.

In the above structure, in the state in which the transmission quality of the wireless communication channel is very poor, the selector 626 selects the 4PSK modulator 623 in accordance with a select instruction sent from the communication channel condition detector 627. In this state, first encoded data (two bits) for real-time reproduction is modulated by the 4PSK modulator 623, and the modulated signal is output to the radio unit as modulated data via the selector 626.

On the other hand, in the state in which the transmission quality of the wireless communication channel is relatively good, the selector 626 selects the 8PSK modulator 624 in accordance with a select instruction sent from the communication channel condition detector 627. In this state, first encoded data (two bits) for real-time reproduction, which is output from the fixed encoder 621, is input to LSB-side two bits of the 8PSK modulator 624, and one bit of second encoded data for non-real-time reproduction, which is read out of the accumulator 622, is input to an MSB-side one bit of the 8PSK modulator 624. The 8PSK modulator 624 generates an 8PSK modulated signal corresponding to the input 2-bit first encoded data and 1-bit second encoded data. The 8PSK modulated signal is output to the radio unit as modulated data via the selector 626.

In the state in which the transmission quality of the wireless communication channel is still better, the selector 626 selects the 16PSK modulator 625 in accordance with a select instruction sent from the communication channel condition detector 627. In this state, first encoded data (two bits) for real-time reproduction, which is output from the fixed encoder 621, is input to LSB-side two bits of the 16PSK modulator 625, and two bits of second encoded data for non-real-time reproduction, which are read out of the accumulator 622, is input to MSB-side two bits of the 16PSK modulator 625. The 16PSK modulator 625 generates a 16PSK modulated signal corresponding to the input 2-bit first encoded data and 2-bit second encoded data. The 16PSK modulated signal is output to the radio unit as modulated data via the selector 626.

In the fourth embodiment, the second encoded data accumulated in the accumulator 622 is modulated and transmitted, without being subjected to error correction encoding processing. Consequently, if the transmission quality deteriorates during transmission of the second encoded data and an error occurs in the second encoded data, the receiving device could not correctly reproduce the second encoded data.

However, the apparatus of this embodiment is equipped with an automatic data retransmission function. Specifically, if an error in the received second encoded data is detected, the receiving device sends an automatic repeat request (ARQ) to the transmission device. The ARQ is received by the retransmission controller 628 provided in the adaptive control unit 620 of the transmission device. Upon receiving the ARQ, the retransmission controller 628 reads out once again the associated data from the accumulator 622 and delivers it to the variable modulator. Therefore, the receiving device can correctly receive and reproduce the second encoded data in which a transmission error has occurred.

### FIFTH EMBODIMENT

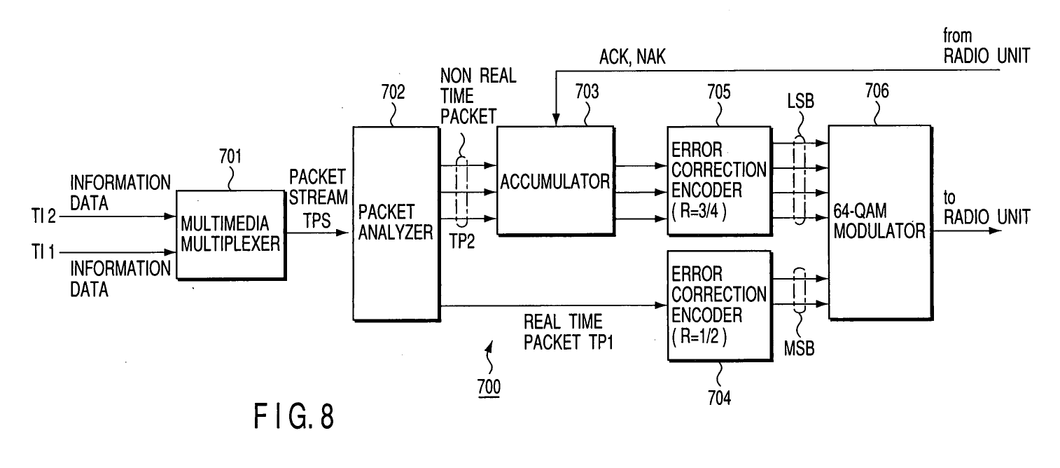

FIG. 8 is a block diagram showing a main structure of a transmission device according to the fifth embodiment of the invention. The transmission device 700 comprises a multimedia multiplexer 701, a packet analyzer 702, an accumulator 703, a first error correction encoder 704, a second error correction encoder 705, and a 64QAM (Quadrature Amplitude Modulation) modulator 706.

The multimedia multiplexer 701 packetizes information data TI1 that has real timeness and information data TI2 that has no real timeness in accordance with a multimedia multiplexing protocol. Then, the real-time packet and the non-real-time packet that have been generated are multiplexed to output a packet stream TPS. For the information data TI1 that has real timeness, there are speech data, audio data, video data for television telephone communication, etc. On the other hand, for the information data TI2 that has no real timeness, there are character data and computer data. As the multimedia multiplexing protocol, for example, a protocol standardized in ITU-T Rec. H.223 is used.

The packet analyzer 702 separates the packets of the packet stream TPS output from the multimedia multiplexer 701 into a real-time packet TP1 and a non-real-time packet TP2 based on identification information contained in headers thereof. Then, the real-time packet TP1 is input to the error correction encoder 704. On the other hand, the non-real-time packet TP2 is first stored in the accumulator 703, and then input to the error correction encoder 705.

The error correction encoder 704 includes an error correction encoder of an encoding rate R=1/2. Redundant bits are added to the input real-time packet TP1 by 1 bit per bit thereof, and the serial data to which the redundancy has been added is converted into 2-bit parallel data to be output.

The error correction encoder 705 includes an error correction encoder of an encoding rate R=3/4. The non-real-time packet TP2 is read out of the accumulator 703, and redundant bits are added to the read-out non-real-time packet TP2 by 1 bit per 3 bits thereof. Then, the serial data to which the redundancy has been added is converted into 4-bit parallel data to be output. That is, an error correction capability stronger than that for the non-real-time packet TP2 is provided to the real-time packet TP1.

An output of the 64QAM modulator 706 is ±7 or ±5 or ±3 or ±1, ±7j or ±5j or ±3j or ±1j. Accordingly, the output of the 64QAM modulator 706 can be considered to be a result of adding an output (±3 or ±1, ±3j or ±1j) of a 16QAM (Quadrature Amplitude Modulation) modulator in which four bits are mapped in complex plane to an output (±4, ±4j) of a 4PSK (Phase Shift Keying) modulator in which two bits are mapped in complex plane. Here, a shortest distance between signal points becomes “8” in the mapping of the 4PSK modulator, while a shortest distance between signal points becomes “2” in the mapping of the 16QAM modulator. That is, a 2-bit input modulated by the 4PSK modulator has a higher error resistance compared with a 4-bit input modulated by the 16QAM modulator.

Thus, the 2-bit parallel data of the error correction encoder 704 is input to two bits of an MSB (Most Significant Bit) side of a 6-bit input of the 64QAM modulator 706, and the 4-bit parallel data of the error correction encoder 705 is input to four bits of an LSB (Least Significant Bit) side of the 64QAM modulator 706. The 64QAM modulator 706 generates a 64QAM modulated signal by mapping the input 6-bit parallel data on 16 points in complex plane, and supplies the generated modulated signal to a radio unit (not shown). The radio unit converts a frequency of the 64QAM modulated signal up to a radio signal frequency, amplifies the radio signal frequency to an optimal transmission power level, and transmits the amplified radio signal to the wireless communication channel via a transmission antenna.

Additionally, the transmission device 700 reads a relevant non-real-time packet out of the accumulator 703 when an NAK (Negative Acknowledge) signal that indicates the occurrence of a bit error arrives from the receiving device (described later). Then, the non-real-time packet is retransmitted to the receiving device.

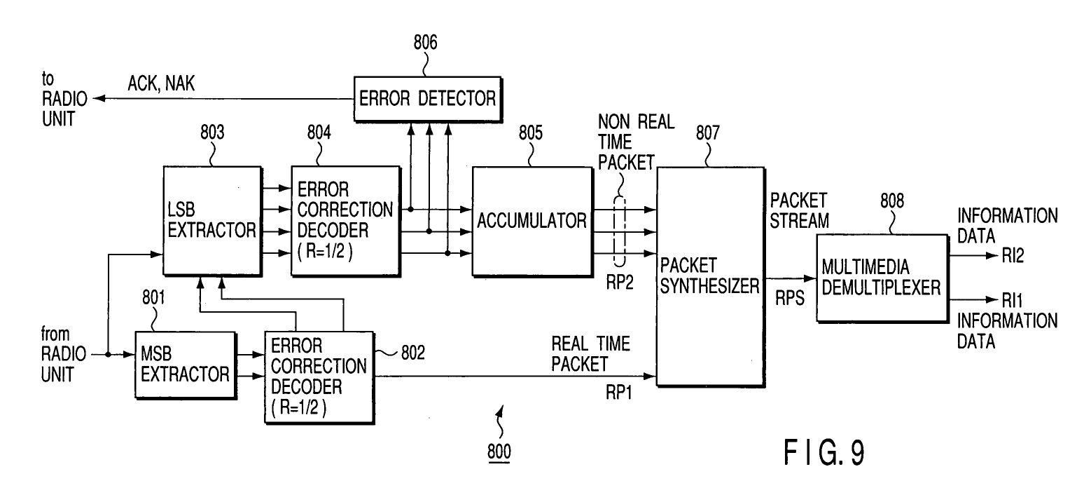

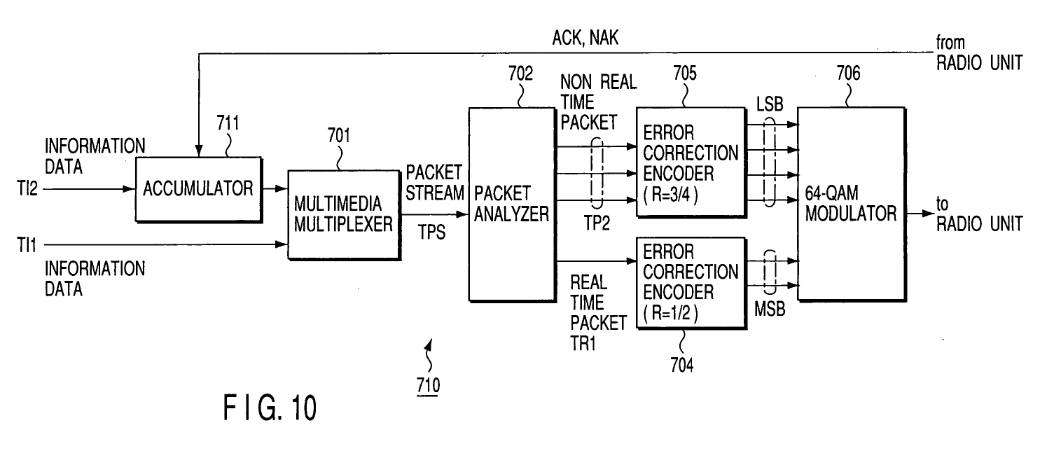

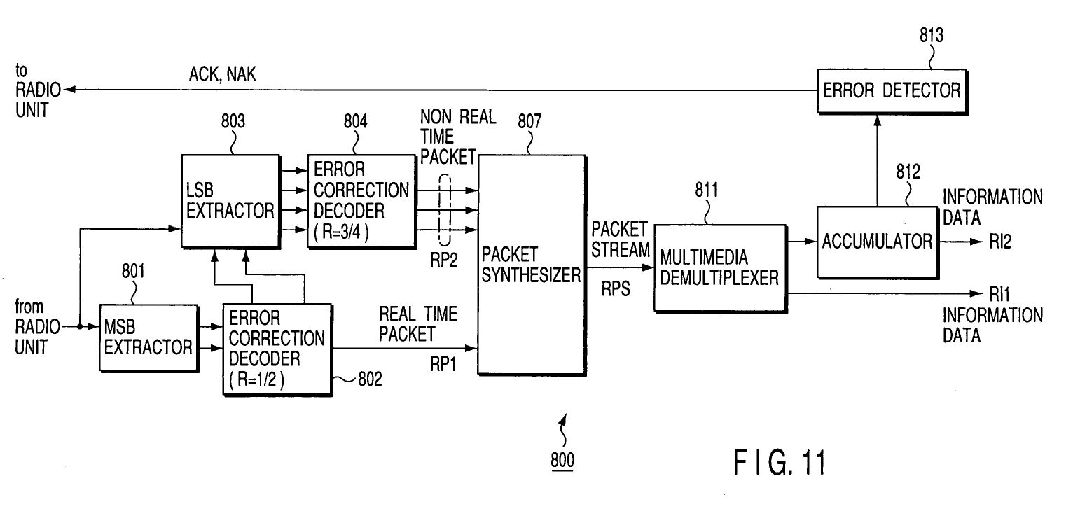

On the other hand, the receiving device is constructed as described below. FIG. 9 is a block diagram showing a main structure of the receiving device. The receiving device 800 comprises an MSB extractor 801, an error correction decoder 802, an LSB extractor 803, an error correction decoder 804, an accumulator 805, an error detector 806, a packet synthesizer 807, and a multimedia demultiplexer 808.

The MSB extractor 801 and the LSB extractor 803 include 64QAM demodulators. The MSB extractor 801 extracts two bits of an MSB side by determining which of four quadrants divided by real number and imaginary number axes the 64QAM modulated signal received by the radio unit (not shown) is present, i.e., by 4PSK demodulation. The error correction decoder 802 includes an error correction decoder of an encoding rate R=1/2. The 2-bit parallel data extracted by the MSB extractor 801 is subjected to error correction decoding, and the error-corrected bit string is output as a reproduced real-time packet RP1 to the packet synthesizer 807.

The LSB extractor 803 extracts 4-bit data of the LSB side by executing 16QAM demodulation for the quadrant of complex plane represented by the 2-bit parallel data extracted by the MSB extractor 801. The error correction decoder 804 includes an error correction decoder of an encoding rate R=3/4. The 4-bit parallel data extracted by the LSB extractor 803 is subjected to error correction decoding. The error-corrected 3-bit parallel data is first stored in the accumulator 805, and then input as a reproduced non-real-time packet RP2 to the packet synthesizer 807.

The packet synthesizer 807 synthesizes the reproduced real-time packet RP1 with the reproduced non-real-time packet RP2 to reproduce a packet stream RPS. The multimedia demultiplexer 808 separates the reproduced packet stream RPS for each packet to reproduce real-time information data R11 and non-real-time information data R12.

The error detector 806 detects whether a bit error is contained or not in the non-real-time packet RP2 reproduced by the error correction decoder 804. This bit error detection is executed by adding a CRC (Cyclic Redundancy Check) bit to the non-real-time packet at the transmission device 700. The error detector 806 transmits an ACK (Acknowledge) signal to the transmission device 700 if a result of the bit error detection shows no bit errors. On the other hand, the error detector 806 transmits an NAK (Negative Acknowledge) signal to the transmission device 700 if an error bit is detected.

As described above, according to the fifth embodiment, the 2-bit parallel data generated by subjecting the real-time packet TP1 to the error correction encoding is input to the two bits of the MSB (Most Significant Bit) side of the 6-bit input of the 64QAM modulator 706. Additionally, the 4-bit parallel data generated by subjecting the non-real-time packet TP2 to the error correction encoding is input to the four bits of the LSB (Least Significant Bit) side of the 64QAM modulator 706. Then, the 64QAM modulated signal generated by the 64QAM modulator 706 is wirelessly transmitted.

Thus, the bit data of the real-time packet TP1 is mapped on one of a high error resistance among sixty four signal points in the complex plane by the 64QAM modulation. As a result, it is possible to transmit the real-time packet by high quality even in the transmission system that uses a wireless communication channel of poor transmission quality. Therefore, the user of the receiving device can continuously watch and hear, e.g., moving image data and audio data.

Furthermore, the CRC bit is added to the non-real-time packet. Then, if a bit error is detected in the non-real-time packet, an NAK signal is returned from the receiving device 800 to the transmission device 700. The transmission device 700 retransmits the non-real-time packet in accordance with the NAK signal. Thus, even the data of the non-real-time packet mapped on a signal point of a relatively low error resistance in the complex plane can be transmitted while required quality is maintained.

The foregoing constitution of the fifth embodiment can be similarly applied to a case of using a 16QAM modulator or a 32PSK modulator in addition to the case of using the 64QAM modulator.

An output (±6 or ±2, ±6j or ±2j) of the 16QAM modulator can be considered to be a result of adding an output (±2, ±2j) of the second 4PSK modulator to an output (±4, ±4j) of the first 4PSK modulator. In this case, a shortest distance between signal points is “8” in mapping of the first 4PSK modulator, while a shortest distance between signal points is “4” in mapping of the second 4PSK modulator. Thus, a 2-bit input of the first 4PSK modulator has a higher error resistance compared with a 2-bit input of the second 4PSK modulator. Here, the former 2-bit input is referred to as an MSB (Most Significant Bit) input of the 16QAM modulator, and the latter 2-bit input is referred to as an LSB (Least Significant Bit) input of the 16QAM modulator.

If an encoding rate of the error correction encoder 704 is R=1/2, the 2-bit parallel data output from the error correction encoder 704 is set to be an MSB input of the 16QAM modulator, while the 2-bit parallel data read out of the accumulator 703 is set to be an LSB input of the 16QAM modulator. At the receiving device, information data are reproduced in order of MSB and LSB by the 16QAM demodulator.

It is two bits of the MSB side in the 5-bit input of the 32PSK modulator that decides one of four quadrants in the complex plane. There are eight signal points in each quadrant, and it is three bits of the LSB side that decides positions thereof.

If an encoding rate of the error correction encoder 704 is, e.g., R=1/2, the 2-bit parallel data output from the error correction encoder 704 is set to be an MSB input of the 32PSK modulator. If an encoding rate of the error correction encoder 705 is, e.g., R=2/3, the 3-bit parallel data output from the error correction encoder 705 is set to be an LSB input of the 32PSK modulator. At the receiving device, information data are reproduced in order of the MSB and the LSB by the 32PSK modulator.

### SIXTH EMBODIMENT

The sixth embodiment of the present invention uses a retransmission function that a multimedia multiplexing protocol standardized in ITU-T Rec. H. 223 Annex C or Annex D includes.

FIGS. 8 and 9 are block diagrams showing main structures of a transmission device 710 and a receiving device 810 according to the sixth embodiment of the invention.

A multimedia multiplexing unit of the transmission device 710 includes a multimedia multiplexer 701 and an accumulator 711. On the other hand, a multimedia multiplexing unit of the receiving device 810 includes a multimedia demultiplexer 811, an accumulator 812 and an error detector 813.

To begin with, the accumulator 812 of the receiving device 810 accumulates non-real-time information data RI2 separated by the multimedia demultiplexer 811. The error detector 813 determines presence of a bit error in the non-real-time information data RI2 accumulated in the accumulator 812. Then, upon detection of the bit error, an NAK signal is returned to the transmission device 710.

On the other hand, when the NAK signal arrives, the accumulator 711 of the transmission device 710 reads out relevant non-real-time information data, and supplies the data to the multimedia multiplexer 701. The multimedia multiplexer 701 multiplexes a packet of the read-out information data TI2 with a packet of real-time information data TI1, and supplies the multiplexed packet to the packet analyzer 702.

Because of such a constitution, it is possible to eliminate the necessity of the accumulators 703, 805 for accumulating the non-real-time packet shown in FIGS. 8 and 9, whereby the structure of the transmission device can be simplified.

### SEVENTH EMBODIMENT

According to the fifth embodiment, the quality of the non-real-time information that has been subjected to the error correction encoding is improved by the retransmission sequence. However, various ideas may be implemented even in the retransmission sequence.

In FIG. 8, the non-real-time packet TP2 is read out of the accumulator 703, and bits thereof are input to, e.g., the error correction encoder of the encoding rate R=1/2. At the error correction encoder, 2-bit redundancy is added to the input non-real-time packet TP2 for every two bits, and a result thereof is output as 4-bit parallel data.

An output of the 64QAM modulator is (±7 or ±5 or ±3 or ±1, ±7j or ±5j or ±3j or ±1j) as described above. This output can be considered to be a result of adding an output (±3 or ±1, ±3j or ±1j) of the 16QAM modulator in which a 4-bit input is mapped in the complex plane to an output (±4, ±4j) of the 4PSK modulator in which a 2-bit input is mapped in the complex plane. Further, an output (±3 or ±1, ±3j or ±1j) of the 16QAM modulator can be considered to be a result of adding an output (±1, ±1j) of the second 4PSK modulator to an output (±2, ±2j) of the first 4PSK modulator. In this case, a shortest distance between signal points is “4” in the first 4PSK modulator, while a shortest distance between signal points is “2” in the second 4PSK modulator. Thus, the 2-bit input of the first 4PSK modulator has a higher error resistance compared with that of the second 4PSK modulator.

Thus, the non-real-time packet TP2 read out of the accumulator 703 is input to, e.g., the error correction encoder of the encoding rate R=1/2. Then, two bits of the 4-bit parallel data output from the error correction encoder are input to the first 4PSK modulator, and the remaining two bits are input to the second 4PSK modulator. Since the first and second 4PSK modulators are similar in function, uniform error protection is supposedly provided to all the bits of the 4-bit parallel data. According to the embodiment, however, since the error resistance of the first 4PSK modulator is higher, nonuniform error protection is provided to the 4-bit parallel data.

Therefore, according to the embodiment, in the retransmission sequence, for example, bits transmitted as LSB by given timing are retransmitted later as LSB or MSB because a noise resistance thereof is low.

Meanwhile, the following two methods have conventionally been presented as the retransmission sequences.

(Conventional Art 1) A method for improving SNR by retransmitting similar information bits and similar parity bits, and adding and synthesizing first-received information data and retransmitted information data at a real value level in the receiving device.

(Conventional Art 2) A method for improving an encoding gain by retransmitting other parity bits in the receiving device. For example, 100-byte parity is generated if 50-byte information data is subjected to error correction encoding by systematic convolution codes of an encoding rate R=1/3. Thus, fifty bytes of the 100-byte parity are transmitted at first transmission, and the remaining fifty bytes are transmitted at second transmission. Error correction decoding of an encoding rate R=1/2 is executed at first reception, and error correction encoding of an encoding rate R=1/3 is executed at second reception.

The above conventional arts are described in S. Parkvall, E. Dahlman, P. Frenger, P. Beming, and M. Persson, “The evolution of WCDMA towards higher speed downlink packet data access”, IEEE Vehicle Technology Conference (VTC) 2001-Spring, pp. 2287-2291, 2001. Especially, the Conventional Art 1 and the Conventional Art 2 are described in detail respectively as Hybrid ARQ of a Chase combining system and Hybrid ARQ of an Incremental redundancy system in the document.

On the other hand, the embodiment presents the following plurality of retransmission sequences to which the conventional arts are applied.

### FIRST EXAMPLE

Case in which the fifty bytes of the non-real-time information data are subjected to error correction encoding by systematic convolution codes of an encoding rate R=1/2 to generate 50-byte parity, and information data to which this parity is added is transmitted.

First Transmission:

The fifty bytes of the information data are input by every two bits as a 2-bit input of the MSB side to the first 4PSK modulator. On the other hand, the fifty bytes of the parity are input by every two bits as a 2-bit input of the LSB side to the second 4PSK modulator.

Second Transmission:

The fifty bytes of the parity are input by every two bits as a 2-bit input of the MSB side to the first 4PSK modulator. On the other hand, the fifty bytes of the information data are input by every two bits as a 2-bit input of the LSB side to the second 4PSK modulator.

Third Transmission and After:

The first and second transmissions are repeated.

In the first example, the parity that has been transmitted as the LSB at the first transmission is transmitted as the MSB at the second transmission. In the receiving device, a real value of a reception signal is stored at first reception, and synthesized with a reception signal value of second reception. Accordingly, SNR is improved. Incidentally, at the second transmission and after, the two bits of the LSB can be omitted, and only the two bits of the MSB can be subjected to 4PSK modulation to be transmitted.

### SECOND EXAMPLE

Case in which the fifty bytes of the non-real-time information data are subjected to error correction encoding by systematic convolution codes of an encoding rate R=1/3 to generate 100-byte parity, and this generated parity is divided by fifty bytes into first and second parity groups.

First Transmission:

The fifty bytes of the information data are input by every two bits as a 2-bit input of the MSB side to the first 4PSK modulator. On the other hand, the fifty bytes of the first parity group are input by every two bits as a 2-bit input of the LSB side to the second 4PSK modulator.

Second Transmission:

The fifty bytes of the first parity group are input by every two bits as a 2-bit input of the MSB side to the first 4PSK modulator. On the other hand, the fifty bytes of the second parity group are input by every two bits as a 2-bit input of the LSB side to the second 4PSK modulator.

Third Transmission:

The fifty bytes of the second parity group are input by every two bits as a 2-bit input of the MSB side to the first 4PSK modulator. On the other hand, the fifty bytes of the information data are input by every two bits as a 2-bit input of the LSB side to the second 4PSK modulator.

Fourth Transmission and After:

The first, second and third transmissions are repeated.

In the second example, the first parity group that has been transmitted as the LSB at the first transmission is transmitted as the MSB at the second transmission. In the receiving device, a real value of a reception signal is stored at first reception, and this stored real value is synthesized with a signal value received at second reception. Accordingly, SNR is improved.

Additionally, the second parity group is transmitted as the LSB at the second transmission. In the receiving device, the first and second parity groups are synthesized at second reception to reproduce 100-byte parity. Then, error correction decoding of an encoding rate R=1/3 is executed based on the reproduced 100-byte parity.

Further, the second parity group that has been transmitted as the LSB at the second transmission is transmitted as the MSB at the third transmission. In the receiving device, a real value of a reception signal is stored at second reception, and this stored real value of the reception signal is synthesized with a signal value received at third reception. Accordingly, SNR is improved.

Additionally, the information bit that has been transmitted as the MSB at the first transmission is transmitted as the LSB at the third transmission. In the receiving device, a real value of a reception signal is stored at first reception, and this stored real value of the reception signal is synthesized with a signal value received at third reception. Accordingly, SNR is improved.

The first and second parity groups are synthesized at third reception to reproduce 100-byte parity. Then, error correction decoding of an encoding rate R=1/3 is executed based on the reproduced 100-byte parity. Incidentally, at the second transmission and after, the two bits of the LSB can be omitted, and only the two bits of the MSB can be subjected to 4PSK modulation to be transmitted.

### THIRD EXAMPLE

Case in which the fifty bytes of the non-real-time information data are subjected to error correction encoding by systematic convolution codes of an encoding rate R=1/3 to generate 100-byte parity, and this generated parity is divided by fifty bytes into first and second parity groups.

First Transmission:

The fifty bytes of the information data are input by every two bits as a 2-bit input of the MSB side to the first 4PSK modulator. On the other hand, the fifty bytes of the first parity group are input by every two bits as a 2-bit input of the LSB side to the second 4PSK modulator.

Second Transmission:

The fifty bytes of the second parity group are input by every two bits as a 2-bit input of the MSB side to the first 4PSK modulator. On the other hand, the fifty bytes of the first parity group are input by every two bits as a 2-bit input of the LSB side to the second 4PSK modulator.

Third Transmission:

The fifty bytes of the first parity group are input by every two bits as a 2-bit input of the MSB side to the first 4PSK modulator. On the other hand, the fifty bytes of the second parity group are input by every two bits as a 2-bit input of the LSB side to the second 4PSK modulator.

Fourth Transmission:

The fifty bytes of the information data are input by every two bits as a 2-bit input of the MSB side to the first 4PSK modulator. On the other hand, the fifty bytes of the second parity group are input by every two bits as a 2-bit input of the LSB side to the second 4PSK modulator.

Fifth Transmission:

The fifty bytes of the second parity group are input by every two bits as a 2-bit input of the MSB side to the first 4PSK modulator. On the other hand, the fifty bytes of the information data are input by every two bits as a 2-bit input of the LSB side to the second 4PSK modulator.

Sixth Transmission:

The fifty bytes of the first parity group are input by every two bits as a 2-bit input of the MSB side to the first 4PSK modulator. On the other hand, the fifty bytes of the information data are input by every two bits as a 2-bit input of the LSB side to the second 4PSK modulator.

Seventh Transmission and After:

The first to sixth transmissions are repeated.

In the third example, the first parity group that has been transmitted as the LSB at the first transmission is transmitted as the LSB at the second transmission. In the receiving device, a real value of a reception signal is stored at first reception, and this stored real value of the reception signal is synthesized with a signal value received at second reception. Accordingly, SNR is improved.

Additionally, the second parity group is transmitted as the MSB at the second transmission. Thus, in the receiving device, the first and second parity groups are synthesized at second reception to reproduce 100-byte parity. Then, error correction decoding of an encoding rate R=1/3 is executed based on the reproduced 100-byte parity.

The first parity group that has been transmitted as the LSB at the second transmission is transmitted as the MSB at the third transmission. In the receiving device, a real value of a reception signal is stored at second reception, and this stored real value of the reception signal is synthesized with a signal value received at third reception. Accordingly, SNR is improved. Further, during the period of the first to sixth transmissions, each of the information data and the first and second parity groups is transmitted twice as the MSB and twice as the LSB. Incidentally, at the second transmission and after, the two bits of the LSB can be omitted, and only the two bits of the MSB can be subjected to 4PSK modulation to be transmitted.

Additionally, in the third example, a turbo-encoder of an encoding rate R=1/3 in which first and second organizational convolution encoders of encoding rates R=1/2 are joined through an interleaver can be used. In this case, for example, if the fifty bytes of the information data are subjected to error correction encoding by the first organizational convolution encoder, 50-byte parity Pa is generated. Further, if the fifty bytes of the interleaved information data are subjected to error correction encoding by the second organizational convolution encoder, 50-byte parity Pb is generated.

Then, after the parities Pa, Pb are subjected to puncturing to be divided into four 25-byte parity groups of Pa1, Pa2, Pb1, and Pb2, the parity groups Pa1 and Pb1 are synthesized to generate a 50-byte parity group Pab1, and the parity groups Pa2 and Pb2 are synthesized to generate a 50-byte parity group Pab2. Thereafter, the first to sixth transmissions are repeated by using the parity groups Pab1 and Pab2.

### EIGHTH EMBODIMENT

According to the seventh embodiment, in the mapping of the 64QAM modulator, the two bits of the MSB side for real-time transmission and the four bits of the LSB side for non-real-time transmission are retransmitted. In the mapping of the 16QAM modulation by the four bits of the LSB side, the error-resistant hierarchical structure of the 16QAM modulation is used. However, an embodiment that uses no hierarchical structure is conceivable.

### FIRST EXAMPLE

Case in which the fifty bytes of the non-real-time information data are subjected to error correction encoding by systematic convolution codes of an encoding rate R=1/3 to generate 100-byte parity, and this parity is subjected to puncturing to be divided by fifty bytes into first and second parity groups.

First Transmission:

The fifty bytes of the information data are subjected to 4PSK modulation to be transmitted by every two bits.

Second Transmission:

If a communication channel condition is bad, the fifty bytes of the first parity group are subjected to 4PSK modulation to be transmitted by every two bits.

If a communication channel condition is good, totally hundred bytes of the first and second parity groups are subjected to 16QAM modulation to be transmitted by every four bits.

Third Transmission:

If a communication channel condition is bad, the fifty bytes of the second parity group are subjected to 4PSK modulation to be transmitted by every two bits.

If a communication channel condition is good, totally hundred bytes of the first and second parity group are subjected to 16QAM modulation to be transmitted by every four bits.

Fourth Transmission and After:

The first, second and third transmissions are repeated, or the second and third transmissions are repeated.

In the first example, at the second transmission, the first parity group is transmitted by the 4PSK modulation of a high noise resistance if the communication channel condition is bad. In the receiving device, error correction decoding of an encoding rate R=1/2 is executed. On the other hand, if the communication channel condition is good, the first and second parity groups are transmitted by the 16QAM modulation of high modulation efficiency. In the receiving device, error correction decoding of an encoding rate R=1/3 is executed.

At the third transmission, the second parity group is transmitted by the 4PSK modulation of a high noise resistance if the communication channel condition is bad. In the receiving device, the first parity group obtained at the second reception and the second parity group obtained at the third reception are synthesized, and error correction decoding of an encoding rate R=1/3 is executed.

On the other hand, if the communication channel condition is good, the first parity group is transmitted by the 16QAM modulation of high modulation efficiency. In the receiving device, stored values of the first and second parity groups obtained at the second reception are synthesized with reception values of the first and second parity groups obtained at the third reception. SNR is accordingly improved, and then error correction decoding of an encoding rate R=1/3 is executed.

A feature of the first example is that the condition of the communication channel is observed and, if the communication channel condition is determined to be good, retransmission is executed by using the multivalued modulation system of high efficiency, whereby more parities are transmitted to reduce the number of retransmission times.

As the parity transmission method, in addition to the above, a Trellis coded 8-PSK modulator in which redundant bits are further added by one bit for each 2-bit parity bit can be used. This modulator is particularly useful when the communication channel condition is bad.

Additionally, a turbo-encoder of an encoding rate R=1/3 in which first and second organizational convolution encoders of encoding rates R=1/2 are joined through an interleaver can be used. In this case, for example, if the fifty bytes of the information data are subjected to error correction encoding by the first organizational convolution encoder, 50-byte parity Pa is generated. Further, if the fifty bytes of the interleaved information data are subjected to error correction encoding by the second organizational convolution encoder, 50-byte parity Pb is generated.

Then, after the parities Pa, Pb are subjected to puncturing to be divided into four 25-byte parity groups of Pa1, Pa2, Pb1, and Pb2, the parity groups Pa1 and Pb1 are synthesized to generate a 50-byte parity group Pab1, and the parity groups Pa2 and Pb2 are synthesized to generate a 50-byte parity group Pab2. Thereafter, the first to sixth transmissions are repeated by using the parity groups Pab1 and Pab2.

### NINTH EMBODIMENT

The seventh and eighth embodiments have been described by way of the sequence of retransmitting the non-real-time information in the system that mixes the real-time information and the non-real-time information by the modulator to transmit the information.

However, the retransmission sequence is not limited to the above system of mixed transmission. The sequence can be applied to a system that transmits only the non-real-time information. In this case, it is only necessary to omit the process of mapping every two bits of the real-time information data in one of the first to fourth quadrants in the complex plane by the 4PSK modulation.

For example, all information data are set to be non-real-time information, and bits mapped on the signal points of the LSB side to be transmitted by given transmission timing are mapped on signal points of the LSB side or the MSB side to be retransmitted by later timing.

### FIRST EXAMPLE

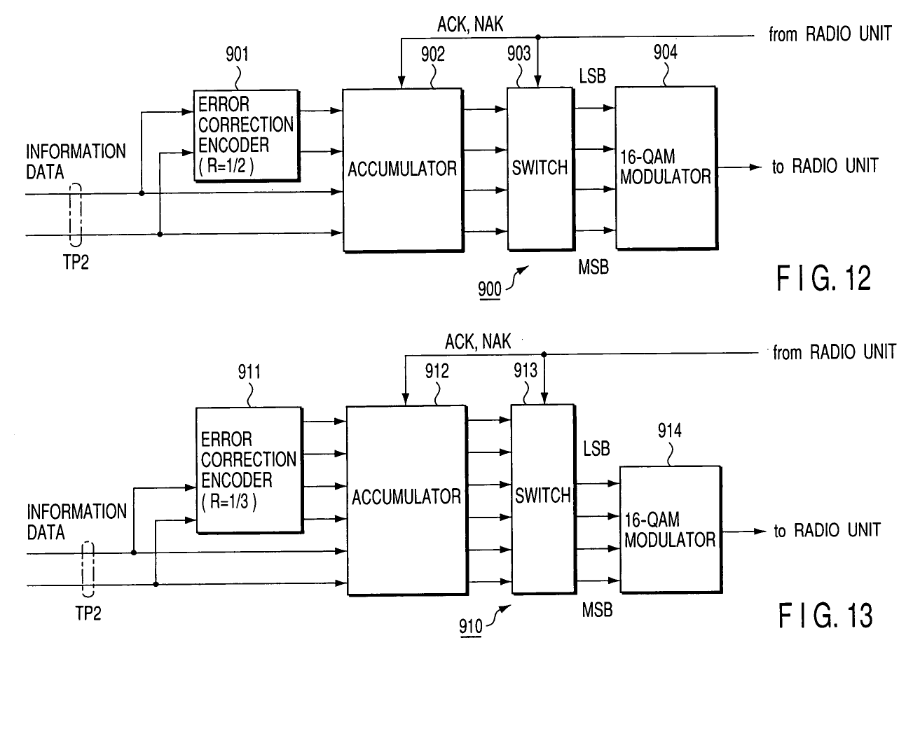

FIG. 12 is a block diagram showing a structure of a transmission device 900 to implement a first example of the ninth embodiment. In the drawing, fifty bytes of non-real-time information data TP2 are input to an error correction encoder 901 of an encoding rate R=1/2. The error correction encoder 901 subjects the input non-real-time information data TP2 to error correction encoding by systematic convolution codes of an encoding rate R=1/2 to generate 50-byte parity. The non-real-time information data TP2 and the generated parity are first accumulated in an accumulator 902, and then selectively input to a 16QAM modulator 904 by a switch 903 to be modulated.

First Transmission:

The fifty bytes of the non-real-time information data are input by every two bits as a 2-bit input of the MSB side to the 16QAM modulator 904. Additionally, the fifty bytes of the parity are input by every two bits as a 2-bit input of the LSB side to the 16QAM modulator 904.

Second Transmission:

The fifty bytes of the parity are input by every two bits as a 2-bit input of the MSB side to the 16QAM modulator 904. Additionally, the fifty bytes of the information data are input by every two bits as a 2-bit input of the LSB side to the 16QAM modulator 904.

Third Transmission and After:

The first and second transmissions are repeated.

In the first example, the parity that has been transmitted as the LSB at the first transmission is transmitted as the MSB at the second transmission. In the receiving device, a real value of a reception signal is stored at first reception, and synthesized with a reception signal value of second reception. Accordingly, SNR is improved.

### SECOND EXAMPLE

FIG. 13 is a block diagram showing a structure of a transmission device 910 to implement a second example of the ninth embodiment. In the drawing, fifty bytes of non-real-time information data TP2 are input to an error correction encoder 911 of an encoding rate R=1/3. The error correction encoder 911 subjects the input non-real-time information data TP2 to error correction encoding by systematic convolution codes of an encoding rate R=1/3 to generate 100-byte parity. Further, the generated 100-byte parity is divided by fifty bytes into first and second parity groups by an accumulator 912 and a switch 913. Then, the non-real-time information data TP2 and the divided first and second parity groups are selectively input to a 16QAM modulator 914 by the switch 913 to be modulated.

First Transmission:

The fifty bytes of the non-real-time information data are input by every two bits as a 2-bit input of the MSB side to the 16QAM modulator 914. On the other hand, the fifty bytes of the first parity group are input by every two bits as a 2-bit input of the LSB side to the 16QAM modulator 914.

Second Transmission:

The fifty bytes of the first parity group are input by every two bits as a 2-bit input of the MSB side to the 16QAM modulator 914. On the other hand, the fifty bytes of the second parity group are input by every two bits as a 2-bit input of the LSB side to the 16QAM modulator 914.

Third Transmission:

The fifty bytes of the second parity group are input by every two bits as a 2-bit input of the MSB side to the 16QAM modulator 914. On the other hand, the fifty bytes of the non-real-time information data are input by every two bits as a 2-bit input of the LSB side to the second 16QAM modulator 914.

Fourth Transmission and After:

The first, second and third transmissions are repeated.

In the second example, the first parity group that has been transmitted as the LSB at the first transmission is transmitted as the MSB at the second transmission. In the receiving device, a real value of a reception signal is stored at first reception, and this stored real value is synthesized with a signal value received at second reception. Accordingly, SNR is improved.

Additionally, the second parity group is transmitted as the LSB at the second transmission. In the receiving device, the first and second parity groups are synthesized at second reception to reproduce 100-byte parity. Then, error correction decoding of an encoding rate R=1/3 is executed based on the reproduced 100-byte parity.

Further, the second parity group that has been transmitted as the LSB at the second transmission is transmitted as the MSB at the third transmission. In the receiving device, a real value of, a reception signal is stored at second reception, and this stored real value of the reception signal is synthesized with a signal value received at third reception. Accordingly, SNR is improved.

Additionally, the information bit that has been transmitted as the MSB at the first transmission is transmitted as the LSB at the third transmission. In the receiving device, a real value of a reception signal is stored at first reception, and this stored real value of the reception signal is synthesized with a signal value received at third reception. Accordingly, SNR is improved.

The first and second parity groups are synthesized at third reception to reproduce 100-byte parity. Then, error correction decoding of an encoding rate R=1/3 is executed based on the reproduced 100-byte parity.

### THIRD EXAMPLE

The fifty bytes of the non-real-time information data are subjected to error correction encoding by systematic convolution codes of an encoding rate R=1/3 to generate 100-byte parity, and this parity is divided by fifty bytes into first and second parity groups. The information data and the parity groups are selectively input to the 16QAM modulator by the switch to be modulated. Incidentally, the structure of the transmission device to realize the third example is similar to that of FIG. 13, and thus description thereof will be omitted.

First Transmission:

The fifty bytes of the information data are input by every two bits as a 2-bit input of the MSB side to the 16QAM modulator 914. Additionally, the fifty bytes of the first parity group are input by every two bits as a 2-bit input of the LSB side to the 16QAM modulator 914.

Second Transmission:

The fifty bytes of the second parity group are input by every two bits as a 2-bit input of the MSB side to the 16QAM modulator 914. Additionally, the fifty bytes of the first parity group are input by every two bits as a 2-bit input of the LSB side to the 16QAM modulator 914.

Third Transmission:

The fifty bytes of the first parity group are input by every two bits as a 2-bit input of the MSB side to the 16QAM modulator 914. Additionally, the fifty bytes of the second parity group are input by every two bits as a 2-bit input of the LSB side to the 16QAM modulator 914.

Fourth Transmission:

The fifty bytes of the information data are input by every two bits as a 2-bit input of the MSB side to the 16QAM modulator 914. Additionally, the fifty bytes of the second parity group are input by every two bits as a 2-bit input of the LSB side to the 16QAM modulator 914.

Fifth Transmission:

The fifty bytes of the second parity group are input by every two bits as a 2-bit input of the MSB side to the 16QAM modulator 914. Additionally, the fifty bytes of the information data are input by every two bits as a 2-bit input of the LSB side to the 16QAM modulator 914.

Sixth Transmission:

The fifty bytes of the first parity group are input by every two bits as a 2-bit input of the MSB side to the 16QAM modulator 914. Additionally, the fifty bytes of the information data are input by every two bits as a 2-bit input of the LSB side to the 16QAM modulator 914.

Seventh Transmission and After:

The first to sixth transmissions are repeated.

In the third example, the first parity group that has been transmitted as the LSB at the first transmission is transmitted as the LSB at the second transmission. In the receiving device, a real value of a reception signal is stored at first reception, and this stored real value of the reception signal is synthesized with a signal value received at second reception. Accordingly, SNR is improved.

Additionally, the second parity group is transmitted as the MSB at the second transmission. Thus, in the receiving device, the first and second parity groups are synthesized at second reception to reproduce 100-byte parity. Then, error correction decoding of an encoding rate R=1/3 is executed based on the reproduced 100-byte parity.

The first parity group that has been transmitted as the LSB at the second transmission is transmitted as the MSB at the third transmission. In the receiving device, a real value of a reception signal is stored at second reception, and this stored real value of the reception signal is synthesized with a signal value received at third reception. Accordingly, SNR is improved. Further, during the period of the first to sixth transmissions, each of the information data and the first and second parity groups is transmitted twice as the MSB and twice as the LSB. Incidentally, at the second transmission and after, the two bits of the LSB can be omitted, and only the two bits of the MSB can be subjected to 4PSK modulation to be transmitted.

Additionally, in the third example, a turbo-encoder of an encoding rate R=1/3 in which first and second organizational convolution encoders of encoding rates R=1/2 are joined through an interleaver can be used.

That is, a point of the third example is that the bits transmitted as the LSB are preferentially retransmitted. There are no restrictions as to transmission of the bits as the MSB or the LSB during retransmission.

### FOURTH EXAMPLE

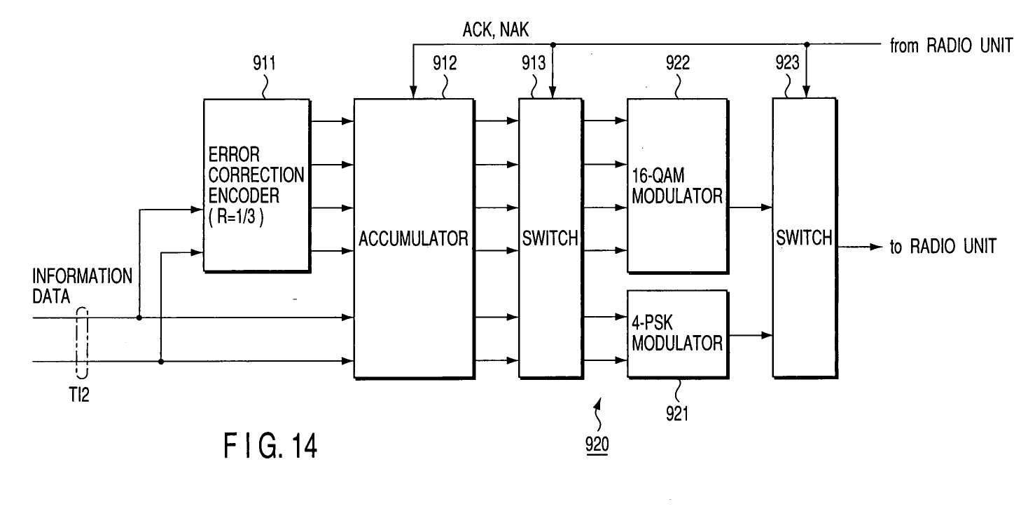

FIG. 14 is a block diagram showing a structure of a transmission device 920 to implement a fourth example of the ninth embodiment. In the drawing, fifty bytes of non-real-time information data TP2 are input to an error correction encoder 911 of an encoding rate R=1/3. The error correction encoder 911 subjects the input non-real-time information data TP2 to error correction encoding by systematic convolution codes of an encoding rate R=1/3 to generate 100-byte parity. Further, the generated 100-byte parity is divided by fifty bytes into first and second parity groups by an accumulator 912 and a switch 913. Then, the non-real-time information data TP2 and the divided first and second parity groups are selectively input to a 4PSK modulator 921 and a 16QAM modulator 922 by the switch 913 to be modulated.

First Transmission:

The fifty bytes of the information data TP2 are input to the 4PSK modulator 921 to be transmitted by every two bits.

Second Transmission:

If a communication channel condition is bad, the fifty bytes of the first parity group are input to the 4PSK modulator 921 to be transmitted by every two bits.

If a communication channel condition is good, totally hundred bytes of the first and second parity groups are input to the 16QAM modulator 922 to be transmitted by every four bits.

Third Transmission:

If a communication channel condition is bad, the fifty bytes of the second parity group are input to the 4PSK modulator 921 to be transmitted by every two bits.

If a communication channel condition is good, totally hundred bytes of the first and second parity group are input to the 16QAM modulator 922 to be transmitted by every four bits.

Fourth Transmission and After:

The first, second and third transmissions are repeated, or the second and third transmissions are repeated.

In the first example, at the second transmission, the first parity group is transmitted by the 4PSK modulation of a high noise resistance if the communication channel condition is bad. In the receiving device, error correction decoding of an encoding rate R=1/2 is executed. On the other hand, if the communication channel condition is good, the first and second parity groups are transmitted by the 16QAM modulation of high modulation efficiency. In the receiving device, error correction decoding of an encoding rate R=1/3 is executed.

At the third transmission, the second parity group is transmitted by the 4PSK modulation of a high noise resistance if the communication channel condition is bad. In the receiving device, the first parity group obtained at the second reception and the second parity group obtained at the third reception are synthesized, and then error correction decoding of an encoding rate R=1/3 is executed.

On the other hand, if the communication channel condition is good, the first parity group is transmitted by the 16QAM modulation of high modulation efficiency. In the receiving device, stored values of the first and second parity groups obtained at the second reception are synthesized with reception values of the first and second parity groups obtained at the third reception. SNR is accordingly improved, and then error correction decoding of an encoding rate R=1/3 is executed.

A feature of the first example is that the condition of the communication channel is observed and, if the communication channel condition is determined to be good, retransmission is executed by using the multivalued modulation system of high efficiency, whereby more parities are transmitted to reduce the number of retransmission times.

Furthermore, a turbo-encoder of an encoding rate R=1/3 in which first and second organizational convolution encoders of encoding rates R=1/2 are joined through an interleaver can be used.

### OTHER EMBODIMENTS

The data transmission apparatus according to the present invention is applicable to a WLAN (Wireless Local Area Network), a TV broadcast system (cable television (CATV)) and a communications satellite system, as well as to a public mobile communications system. This apparatus is applicable to not only a wireless communication channel but also a wired communication channel, if the transmission quality of the channel varies with the passing of time.

Besides, without departing from the spirit of the present invention, various modifications can be made to the encoding ratio used in the variable encoders, the modulation scheme used in the variable modulators, the circuitry structure of the apparatus, and the kind, format, use application, etc. of information data to be transmitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data transmission apparatus that transmits information data, whose generated information amount varies with passing of time, to a communication channel whose transmission quality varies with passing of time, comprising:
a separation unit configured to separate the information data into a first information component necessary for real-time reproduction and a second information component other than the first information component;
a first encoding unit configured to encode the separated first information component according to a first encoding scheme corresponding to a first transmission rate that is always secured on the communication channel, thereby outputting first encoded information data;
a second encoding unit configured to accumulate the separated second information component and encode the separated second information component according to a second encoding scheme corresponding to a second transmission rate that is other than the first transmission rate and is irregularly secured on the communication channel, thereby outputting second encoded information data;
a modulation unit configured to produce a modulated signal on the basis of the first encoded information data output from the first encoding unit and the second encoded information data output from the second encoding unit; and
a transmission unit configured to transmit the modulated signal produced by the modulation unit to the communication channel.

2. The data transmission apparatus according to claim 1, wherein the separation unit extracts the first information component by quantizing the information data to be transmitted, and extracts, as the second information component, an information component that is lost by the quantization.

3. The data transmission apparatus according to claim 1, further comprising an adding unit configured to add timestamps to the first information component and the second information component, the timestamps being representative of a temporal correspondence relationship between the first information component and the second information component.

4. The data transmission apparatus according to claim 1, further comprising a control unit configured to perform, based on the transmission quality of the communication channel, at least one of a process of adaptively variable-setting the second encoding scheme used in the second encoding unit, and a process of adaptively variable-setting a modulation scheme used in the modulation unit.

5. A data transmission apparatus comprising:
a reception unit configured to receive a modulated signal transmitted over a communication channel whose transmission quality varies with passing of time;
a demodulation unit configured to demodulate the received modulated signal and to output first demodulated data and second demodulated data;
a first decoding unit configured to decode the first demodulated data output from the demodulation unit according to a first decoding scheme corresponding to a first transmission rate that is always secured on the communication channel, thereby outputting first decoded data;
a second decoding unit configured to decode the second demodulated data output from the demodulation unit according to a second decoding scheme corresponding to a second transmission rate that is different from the first transmission rate and is irregularly secured on the communication channel, thereby outputting second decoded data;
a first reproduction unit configured to reproduce first information data in real time on the basis of the first decoded data output from the first decoding unit;
a synthesis unit configured to synthesize the first decoded data output from the first decoding unit and the second decoded data output from the second decoding unit; and
a second reproduction unit configured to reproduce second information data on the basis of the synthesized decoded data.

6. The data transmission apparatus according to claim 5, wherein the synthesis unit includes:
a memory configured to accumulate the first decoded data;
means for extracting timestamps from the first and second decoded data, the timestamps being representative of a temporal correspondence relationship between the first and second decoded data; and
means for synthesizing the first decoded data accumulated in the memory and the second decoded data output from the second decoding unit, with the temporal correspondency relationship being established on the basis of the extracted timestamps.

7. The data transmission apparatus according to claim 5, wherein the demodulation unit includes:
means for determining a modulation scheme used for modulation of the received modulated signal; and
means for performing a demodulation process for the received modulated signal by selectively using a demodulation scheme corresponding to the determined modulation scheme.

8. The data transmission apparatus according to claim 5, wherein the second decoding unit includes:
means for determining a second encoding scheme used for encoding of the second demodulated data output from the demodulation unit; and
means for performing a decoding process for the second demodulated data by selectively using a second decoding scheme corresponding to the determined second encoding scheme.

9. A data transmission apparatus that transmits first information data, which requires real-time reproduction, and second information data, which requires lossless reproduction, to a communication channel whose transmission quality varies with passing of time, comprising:
a first encoding unit configured to encode the first information data according to a first encoding scheme corresponding to a first transmission rate that is always secured on the communication channel, thereby outputting first encoded information data;
a second encoding unit configured to accumulate the second information data and to encode the second information data according to a second encoding scheme corresponding to a second transmission rate that is different from the first transmission rate and is irregularly secured on the communication channel, thereby outputting second encoded information data;
a modulation unit configured to produce a modulated signal on the basis of the first encoded information data output from the first encoding unit and the second encoded information data output from the second encoding unit; and
a transmission unit configured to transmit the modulated signal produced by the modulation unit to the communication channel.

10. The data transmission apparatus according to claim 9, further comprising a control unit configured to perform, based on the transmission quality of the communication channel, at least one of a process of adaptively variable-setting the second encoding scheme used in the second encoding unit, and a process of adaptively variable-setting a modulation scheme used in the modulation unit.

11. A data transmission apparatus which receives a modulated signal transmitted over a communication channel whose transmission quality varies with passing of time, comprising:
a reception unit configured to receive the modulated signal transmitted over the communication channel;
a demodulation unit configured to demodulate the received modulated signal and to output first demodulated data and second demodulated data;
a first decoding unit configured to decode the first demodulated data output from the demodulation unit according to a first decoding scheme corresponding to a first transmission rate that is always secured on the communication channel, thereby outputting first decoded data that requires real-time reproduction; and
a second decoding unit configured to decode the second demodulated data output from the demodulation unit according to a second decoding scheme corresponding to a second transmission rate that is different from the first transmission rate and is irregularly secured on the communication channel, thereby outputting second decoded data that requires lossless reproduction.

12. The data transmission apparatus according to claim 11, wherein the demodulation unit includes:
means for determining a modulation scheme used for modulation of the received modulated signal; and
means for performing a demodulation process for the received modulated signal by selectively using a demodulation scheme corresponding to the determined modulation scheme.

13. The data transmission apparatus according to claim 11, wherein the second decoding unit includes:
means for determining a second encoding scheme used for encoding of the second demodulated data output from the demodulation unit; and
means for performing a decoding process for the second demodulated data by selectively using a second decoding scheme corresponding to the determined second encoding scheme.

14. A data transmission method comprising:
separating, in a first data transmission apparatus, information data, whose generated information amount varies with passing of time, into a first information component necessary for real-time reproduction and a second information component other than the first information component;
encoding the separated first information component according to a first encoding scheme corresponding to a first transmission rate that is always secured on a communication channel whose transmission quality varies with passing of time, thereby outputting first encoded information data;
accumulating the separated second information component and encoding the second information component according to a second encoding scheme corresponding to a second transmission rate that is different from the first transmission rate and is irregularly secured on the communication channel, thereby outputting second encoded information data;
producing a modulated signal on the basis of the first encoded information data and the second encoded information data;
transmitting the produced modulated signal to the communication channel;
receiving, in a second data transmission apparatus, the modulated signal transmitted over the communication channel;
demodulating the received modulated signal and outputting first demodulated data corresponding to the first encoded information data and second demodulated data corresponding to the second encoded information data;
decoding the output first demodulated data according to a first decoding scheme corresponding to the first encoding scheme, thereby outputting first decoded data corresponding to the first information component;
decoding the output second demodulated data according to a second decoding scheme corresponding to the second encoding scheme, thereby outputting second decoded data corresponding to the second information component;
reproducing the first information component in real time on the basis of the output first decoded data;
synthesizing the output first decoded data and the output second decoded data; and
reproducing reception information data corresponding to the transmitted information data on the basis of the synthesized decoded data.

15. A data transmission method comprising:
encoding, in a first data transmission apparatus, first information data, which requires real-time reproduction, according to a first encoding scheme corresponding to a first transmission rate that is always secured on a communication channel whose transmission quality varies with passing of time, thereby outputting first encoded information data;
accumulating second information data which requires lossless reproduction;
encoding the accumulated second information data according to a second encoding scheme corresponding to a second transmission rate that is different from the first transmission rate and is irregularly secured on the communication channel, thereby outputting second encoded information data;
producing a modulated signal on the basis of the output first encoded information data and the output second encoded information data;
transmitting the produced modulated signal to the communication channel;
receiving, in a second data transmission apparatus, the modulated signal transmitted over the communication channel;
demodulating the received modulated signal and outputting first demodulated data corresponding to the first encoded information data and second demodulated data corresponding to the second encoded information data;
decoding the output first demodulated data according to a first decoding scheme corresponding to the first encoding scheme, thereby outputting first decoded data corresponding to the transmitted first information data; and
decoding the output second demodulated data corresponding to the second encoded information data according to a second decoding scheme corresponding to the second encoding scheme, thereby outputting second decoded data corresponding to the transmitted second information data.

16. A data transmission apparatus, comprising:
a data generation unit configured to generate parallel bit data constituted of a first bit block to which first data is allocated and a second bit block to which second data lower is allocated;
a modulation unit configured to map the first bit block of the generated parallel bit data on one of a plurality of first signal points arranged at a first distance between signal points in complex plane, and the second bit block of the generated parallel bit data on one of a plurality of second signal points arranged at a second distance between signal points shorter than the first distance in the complex plane; and
a transmission unit configured to transmit a modulated signal produced by the modulation unit to a receiving device.

17. The data transmission apparatus according to claim 16, wherein if the first data is higher in importance than the second data, the data generation unit executes error correction encoding for at least the first of the first and second data, and allocates the first data that has been subjected to the error correction encoding to the first bit block.

18. The data transmission apparatus according to claim 16, wherein the data generation unit includes:
a packet separator configured to separate a first packet into which real-time data has been inserted and a second packet into which non-real-time data has been inserted from an input packet stream; and
a circuit configured to allocate the separated first packet as the first data to the first bit block, and the separated second packet as the second data to the second bit block.

19. The data transmission apparatus according to claim 16, further comprising:
a memory configured to store the second data; and
a reception unit configured to receive a retransmission request sent from the receiving device, wherein the data generation unit reads out the second data to be retransmitted from the memory in accordance with the received retransmission request, and allocates the read-out second data to the second bit block.

20. The data transmission apparatus according to claim 19,
wherein the data generation unit counts the number of times of receiving the retransmission request, and switches an allocation destination of the read-out second data between the first bit block and the second bit block in accordance with the number of receiving times.

21. The data transmission apparatus according to claim 19, wherein:
the data generation unit constitutes the read-out second data of third data and fourth data lower in importance than the third data, constitutes the second bit block of a third bit block and a fourth bit block, and allocates the third data to the third bit block and the fourth data to the fourth bit block; and
the modulation unit maps the third data of the third bit block on one of a plurality of third signal points arranged at a third distance between signal points among the plurality of second signal points in the complex plane, and the fourth data of the fourth bit block on one of a plurality of fourth signal points arranged at a fourth distance between signal points shorter than the third distance among the plurality of second signal points in the complex plane.

22. The data transmission apparatus according to claim 21,
wherein the data generation unit counts the number of times of receiving the retransmission request, and switches allocation destinations of the third data and the fourth data of the read-out second data between the third bit block and the fourth bit block in accordance with the number of receiving times.

23. The data transmission apparatus according to claim 16, further comprising:
a memory configured to store the first and second data; and
a reception unit configured to receive the retransmission request sent from the receiving device,
wherein the data generation unit selectively reads out the first and second data to be retransmitted from the memory in accordance with the received retransmission request, and selectively allocates the read-out data to the first and second bit blocks.

24. The data transmission apparatus according to claim 23,
wherein the data generation unit counts the number of times of receiving the retransmission request, and switches allocation destinations of the read-out first and second data between the first bit block and the second bit block in accordance with the number of receiving times.

25. A data transmission apparatus, comprising:
a reception unit configured to receive a modulated signal sent from a transmission device;
a demodulation unit configured to demodulate a first bit block mapped on one of a plurality of first signal points arranged at a first distance between signal points in complex plane and a second bit block mapped on one of a plurality of second signal points arranged at a second distance between signal points shorter than the first distance in the complex plane from the received modulated signal; and
a data reproduction unit configured to reproduce first data and second data from the first bit block and the second bit block that have been demodulated.

26. The data transmission apparatus according to claim 25, wherein if the first data is higher in importance than the second data, the data reproduction unit executes error correction decoding for at least the first of the demodulated first and second bit blocks to reproduce the first data.

27. The data transmission apparatus according to claim 25, wherein the data reproduction unit includes:
a circuit configured to reproduce a first packet into which real-time data has been inserted from the demodulated first bit block;
a circuit configured to reproduce a second packet into which non-real-time data has been inserted from the demodulated second bit block; and
a circuit configured to generate a packet stream by multiplexing the reproduced first and second packets.

28. The data transmission apparatus according to claim 25, further comprising:
an error detector configured to determine whether an error is contained or not in the reproduced second data; and
a transmission unit configured to transmit a retransmission request to a transmission device if the error is determined to be contained in the second data,
wherein the data reproduction unit synthesizes data determined to contain the error with data retransmitted from the transmission device with respect to the transmission of the retransmission request to reproduce the second data.

29. The data transmission apparatus according to claim 25, further comprising:
an error detector configured to determine whether errors are contained or not in the reproduced first and second data; and
a transmission unit configured to transmit the retransmission request to the transmission device if an error is determined to be contained in at least one of the first and second data,
wherein the data reproduction unit synthesizes the data determined to contain the error with data retransmitted from the transmission device with respect to the transmission of the retransmission request to reproduce the first and second data.
